(19) United States
(12) Patent Application Publication
(10) Pub. No.: US 2017/0356354 A1
(43) Pub. Date: Dec. 14, 2017

(54) CONTROL DEVICE

(71) Applicant: DENSO CORPORATION, Kariya-city, Aichi-pref. (JP)

(72) Inventors: Yamato SAKAKIBARA, Kariya-city (JP); Daiji ISOBE, Kariya-city (JP)

(21) Appl. No.: 15/532,636

(22) PCT Filed: Nov. 26, 2015
(86) PCT No.: PCT/JP2015/005863

§ 371 Date: Jun. 2, 2017

(30) Foreign Application Priority Data
Dec. 5, 2014 (JP) 2014-247099

(51) Int. Cl. F02D 13/06; F02D 41/14; F02D 17/02; F02D 41/24; F02D 41/00; F02D 45/00

(52) U.S. Cl. CPC F02D 13/06; F02D 41/2454; F02D 41/0085; F02D 41/1481; F02D 17/026; F02D 41/1458; F02D 45/00; F02D 2041/1433

(57) ABSTRACT

In a case where an internal combustion engine is executing an all-cylinder operation to operate all cylinders, an air-fuel ratio estimation part of an ECU 1 estimates an air-fuel ratio of each of the cylinders by using a first observer. On the other hand, in a case where the internal combustion engine is executing a cylinder-cut operation to rest a part of the cylinders and to operate other of the cylinders, the air-fuel ratio estimation part does not estimate the air-fuel ratio of each of the cylinders by using the first observer.

### CROSS REFERENCE TO RELATED APPLICATIONS

This application is based on Japanese Patent Application No. 2014-247099 filed on Dec. 5, 2014, the disclosure of which is incorporated herein by reference.

### TECHNICAL FIELD

The present disclosure relates to a control device that controls an operation of an internal combustion engine having a plurality of cylinders and that controls an air-fuel ratio of each of the cylinders on the basis of sensed information of an air-fuel ratio sensor provided in an exhaust collection part in which an exhaust gas exhausted from each of the cylinders is collected.

### BACKGROUND ART

In a control device that controls an operation of an internal combustion engine, there is proposed a control device that corrects an amount of fuel to be supplied to a cylinder in order to make an air-fuel ratio correspond to a target value. However, in a case of an internal combustion engine having a plurality of cylinders, an amount of fuel to be supplied to each of the cylinders is varied for each of the cylinders by a machine difference and a secular change of a fuel injection part, which results in causing a variation in also the air-fuel ratio for each of the cylinders. It is concerned that this variation may impair a fuel consumption of the internal combustion engine and an exhaust gas component.

In contrast to this, in the following patent literature 1 is disclosed a control device that performs a control (hereinafter referred to as “individual cylinder air-fuel ratio control”) to estimate an air-fuel ratio for each of cylinders and to correct also an amount of fuel to be supplied for each of the cylinders to thereby eliminate a variation in the air-fuel ratio for each of the cylinders. Here, an air-fuel ratio sensor is provided in an exhaust collection part in which an exhaust gas exhausted from each of the cylinders is collected. The control device disclosed in the following patent literature 1 estimates the air-fuel ratio on the basis of sensed information of the air-fuel ratio sensor and model information such that a value of the air-fuel ratio sensor is affected by an air-fuel ratio of the other cylinder of the last time. In this way, the air-fuel ratio sensor is not provided for each of the cylinders to thereby inhibit an increase in a manufacturing cost and, at the same time, the air-fuel ratio is estimated for each of the cylinders to thereby be able to eliminate a variation in the air-fuel ratio and to improve a fuel consumption and an emission.

In addition, a control device that makes an internal combustion engine execute a cylinder-cut operation has been widely employed. The cylinder-cut operation means that in a case where an operation of the internal combustion engine satisfies a predetermined condition, of a plurality of cylinders of the internal combustion engine, a part of the cylinders is rested and the other of the cylinders are operated.

“An operation” of the cylinder means that an intake valve and an exhaust valve of the cylinder are brought into a state where those valves can be opened and closed and that the fuel is supplied to the cylinder and is combusted. Further, “a rest” of the cylinder means that the intake valve and the exhaust valve of the cylinder are held in a closed state to thereby stop supplying the fuel, that is, to stop combusting the fuel in the cylinder. In this way, when a part of the cylinders is rested, a pumping loss is reduced and hence a fuel consumption can be improved.

In the individual cylinder air-fuel ratio control disclosed in the patent literature 1 described above, an algorithm is constructed on the assumption that all cylinders of the internal combustion engine are operated. When the algorithm is applied to the internal combustion engine that executes the cylinder-cut operation as it is, it is concerned that when the internal combustion engine is executing the cylinder-cut operation, the air-fuel ratio is not suitably estimated and the amount of fuel to be supplied is not suitably corrected.

In other words, according to the algorithm described above, even when the internal combustion engine is executing the cylinder-cut operation, the air-fuel ratio is estimated and the amount of fuel to be supplied is corrected for all cylinders. However, the fuel is not combusted in the cylinder that is rested, so that information sensed by the air-fuel ratio sensor becomes the information of only the exhaust gas exhausted from combustion in the cylinder that is operated.

In short, according to the algorithm described above, when the air-fuel ratio is estimated, an effect caused by a part of the cylinders being rested is not taken into account, so that an estimated value of the air-fuel ratio is extremely deviated from an actual value of the air-fuel ratio. Hence, an erroneous correction of the amount of fuel to be supplied is made for the cylinder which is operated, which is likely to impair an exhaust gas component and drivability.

### PRIOR ART LITERATURES

### Patent Literature

Patent Literature 1: JP 2005-207405 A

### SUMMARY OF THE INVENTION

It is an objective of the present disclosure to provide a control device that can suitably estimate an air-fuel ratio to thereby prevent a malfunction from being caused when the internal combustion engine is executing a cylinder-cut operation.

According to one aspect of the present disclosure, in a control device that controls an operation of an internal combustion engine having a plurality of cylinders and that controls an air-fuel ratio of each of the cylinders on the basis of sensed information of an air-fuel ratio sensor provided in an exhaust collection part in which an exhaust gas exhausted from each of the cylinders is collected, the control device includes: an all-cylinder operation execution part that executes an all-cylinder operation to operate all of the plurality of cylinders; a cylinder-cut operation execution part that executes a cylinder-cut operation to rest a part of the cylinders of the plurality of cylinders and to operate the other of the cylinders; an operation shift part that shifts one of the all-cylinder operation and the cylinder-cut operation to the other of them; an operation state determination part that determines which of an operation state where the internal combustion engine is executing the all-cylinder operation, an operation state where the internal combustion engine is executing the cylinder-cut operation, and an operation state where the internal combustion engine is shifting to one of the all-cylinder operation and the cylinder-cut operation, the internal combustion engine is in on the basis of the operation shift part and the sensed information of the air-fuel ratio sensor; an air-fuel ratio estimation part that estimates an air-fuel ratio of each of the cylinders on the basis of the sensed information of the air-fuel ratio sensor; and a fuel correction part that corrects an amount of fuel to be supplied to each of the cylinders on the basis of the air-fuel ratio of each of the cylinders which is estimated by the air-fuel ratio estimation part. In a case where the internal combustion engine is executing the all-cylinder operation, the air-fuel ratio estimation part estimates the air-fuel ratio of each of the cylinders by using a first observer, whereas in a case where the internal combustion engine is executing the cylinder-cut operation, the air-fuel ratio estimation part does not estimate the air-fuel ratio of each of the cylinders by using the first observer.

According to the present disclosure, in the case where the internal combustion engine is executing the all-cylinder operation, the air-fuel ratio estimation part estimates the air-fuel ratio of each of the cylinders by using the first observer. On the other hand, in the case where the internal combustion engine is executing the cylinder-cut operation, the air-fuel ratio estimation part does not estimate the air-fuel ratio of each of the cylinders by using the first observer. For this reason, it is possible to prevent the following trouble: that is, when the internal combustion engine is executing the cylinder-cut operation in which the part of the cylinders is rested, the air-fuel ratio is estimated and the amount of fuel to be supplied is corrected for all cylinders. Hence, it is possible to prevent a malfunction such as impairment of an exhaust gas component and drivability from being caused when the internal combustion engine is executing the cylinder-cut operation.

According to the present disclosure, it is possible to provide a control device that can suitably estimate an air-fuel ratio and can prevent a malfunction from being caused when the internal combustion engine is executing the cylinder-cut operation.

### BRIEF DESCRIPTION OF THE DRAWINGS

The above and other objects, features, and advantages of the present disclosure will become more apparent from the following detailed description made with reference to the accompanying drawings.

FIG. 1 is a general construction diagram of a drive system to which an ECU related to an embodiment of the present disclosure is applied.

FIG. 2 is a control block diagram to illustrate functional blocks of the ECU shown in FIG. 1.

FIG. 3 is a flow chart of a base routine of the ECU related to the embodiment of the present disclosure.

FIG. 4 is a flow chart to show a flow of processing in an individual cylinder air-fuel ratio control permission determination routine shown in FIG. 3.

FIG. 5 is a time chart to show an example of a control performed by the ECU related to the embodiment of the present disclosure.

FIG. 6 is a flow chart to show a flow of processing in an operated cylinder state determination routine shown in FIG. 3.

FIG. 7 is a time chart to show an example of a control performed by the ECU related to the embodiment of the present disclosure.

FIG. 8 is a flow chart to show a part of a flow of processing in a sensor value acquisition timing calculation routine shown in FIG. 3.

FIG. 9 is a flow chart to show other part of the flow of processing in the sensor value acquisition timing calculation routine shown in FIG. 3.

FIG. 10 is a time chart to show an example of a control performed by the ECU related to the embodiment of the present disclosure.

FIG. 11 is a flow chart to show a flow of processing in an individual cylinder air-fuel ratio estimation routine shown in FIG. 3.

FIG. 12 is a time chart to show an example of a control performed by the ECU related to the embodiment of the present disclosure.

FIG. 13 is a flow chart to show a flow of processing in an individual cylinder fuel correction amount calculation routine shown in FIG. 3.

### EMBODIMENT FOR CARRYING OUT INVENTION

Hereinafter, an embodiment of the present disclosure will be described with reference to the accompanying drawings. For easy understanding, the same constituent elements in each of the drawings will be denoted by the same reference symbols as far as possible and duplicate descriptions of the constituent elements will be omitted.

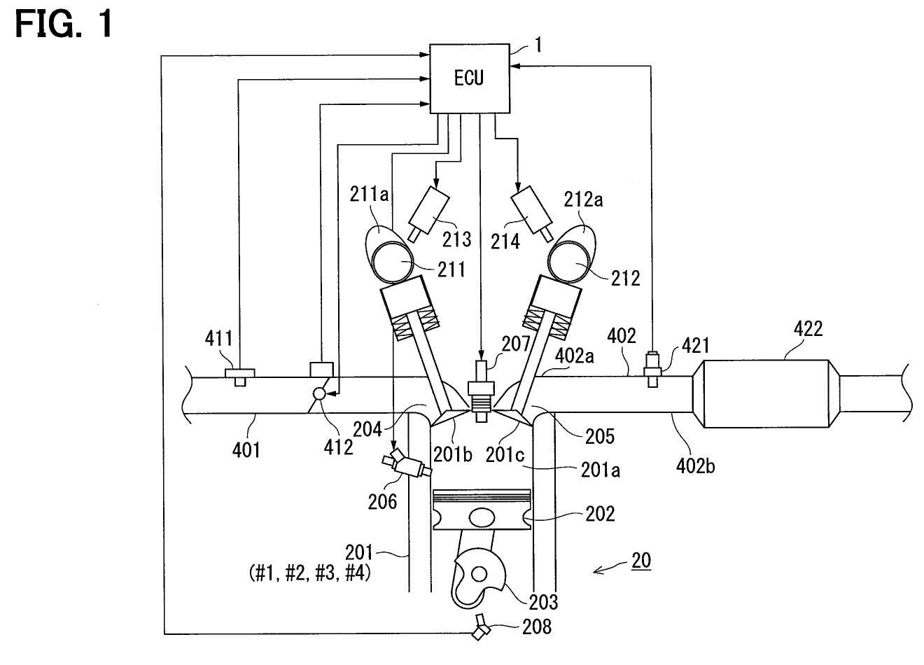

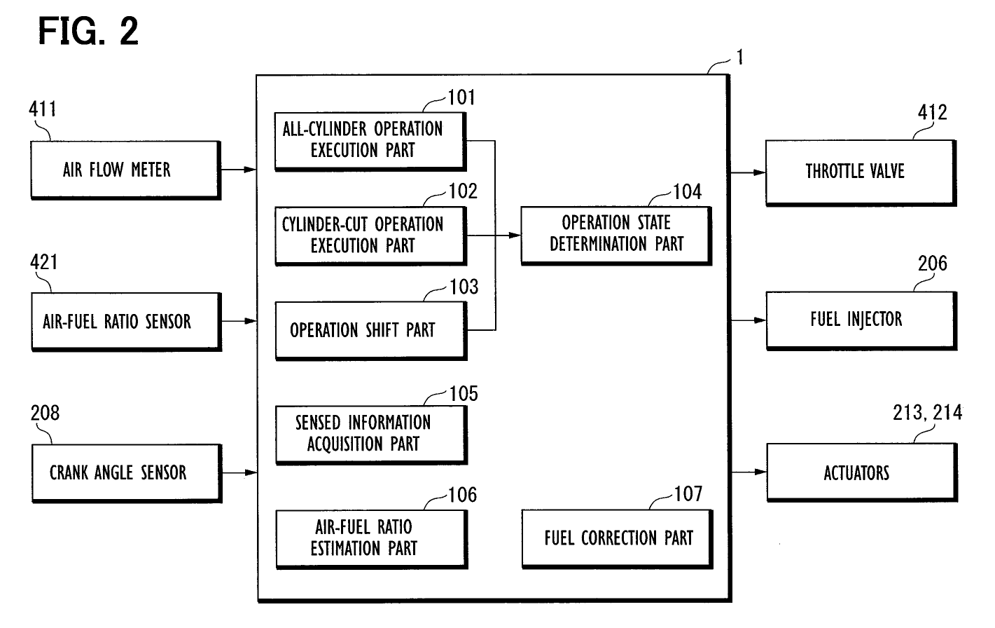

First, an ECU 1 related to an embodiment of the present disclosure will be described with reference to FIG. 1 and FIG. 2. The ECU1 is applied to a drive system of a vehicle. First, a construction of an internal combustion engine 20 which is an object to be controlled by the ECU1 will be described.

The internal combustion engine 20 is a gasoline engine that combusts gasoline of fuel to thereby generate a driving force of a passenger car. The internal combustion engine 20 is provided with a cylinder 201, a piston 202, a crankshaft 203, an intake port 204, an exhaust port 205, a fuel injector 206, and an ignition plug 207.

The internal combustion engine 20 is provided with four cylinders 201. In FIG. 1, as a matter of convenience, only one cylinder 201 will be shown in FIG. 1 but, in reality, the internal combustion engine 20 is provided with a first cylinder #1, a second cylinder #2, a third cylinder #3, and a fourth cylinder #4 in a depth direction. In each of the cylinders 201 is arranged the piston 202 which is reciprocated in a vertical direction. The respective pistons 202 are coupled to each other by the crankshaft 203 and are reciprocated in the vertical direction at different timings.

A combustion chamber 201a is formed between an upper inner wall surface and the piston 202 in each of the cylinders 201. Each of the cylinders 201 is provided with the intake port 204, which introduces air into the combustion chamber 201a, and the exhaust port 205 which exhausts an exhaust gas from the combustion chamber 201a. Each of the cylinders 201 is provided with an intake valve 201b, which opens and closes a portion between the intake port 204 and the combustion chamber 201a, and an exhaust valve 201c which opens and closes a portion between the exhaust port 205 and the combustion chamber 201a. In the intake valve 201b, its upper end portion abuts on a camshaft 211. Further, in the exhaust valve 201c, its upper end portion abuts on the camshaft 212. Still further, above each of the cylinders 201 are provided an actuator 213 which prohibits the intake valve 201b from moving up and an actuator 214 which prohibits the exhaust valve 201c from moving up.

Each of the cylinders 201 is provided with the fuel injector 206, the ignition plug 207, and a crank angle sensor 208. The fuel injector 206 is fixed in such a way that its tip portion faces an interior of the combustion chamber 201a. The fuel injector 206 directly injects the fuel into the combustion chamber 201a from its tip portion. Since the fuel is supplied to the fuel injector 206 at high pressure, the injected fuel is atomized immediately after the fuel is injected. In this regard, the present embodiment employs a direct injection type in which the fuel is directly injected into the combustion chamber 201a, but the present disclosure is not limited to this type. The crank angle sensor 208 is a sensor which outputs a crank signal every time the crankshaft 203 rotates a specified angle in synchronization with the rotation of the crankshaft 203.

Each of the cylinders 201 has an intake pipe 401 and an exhaust pipe 402 connected thereto. The intake pipe 401 has a flow passage to introduce air into the intake port 204 of each of the cylinders 201. The exhaust pipe 402 has a flow passage to guide the exhaust gas to the outside from the exhaust port 205 of each of the cylinders 201. The exhaust pipe 402 is formed in a shape of a manifold and has branch parts 402a, which are branched to four parts, on an upstream side thereof (in FIG. 1, as a matter of convenience, only one branch part 402a will be shown). Each of the four branch parts 402a is coupled to each of the cylinders 201. The exhaust gas flowing in from each of the branch parts 402a is collected in an exhaust collection part 402b on a downstream side thereof, thereby joining together and further flowing to the downstream side.

The intake pipe 401 is provided with an air flow meter 411. The air flow meter 411 measures a flow rate of the air flowing in the flow passage in the intake pipe 401 and transforms the flow rate into an electric signal and outputs the electric signal. Further, the intake pipe 401 is provided with a throttle valve 412 on the downstream side of a portion thereof in which the air flow meter 411 is provided. The throttle valve 412 is constructed in such a way as to regulate a throttle opening when driven by an electric motor (not shown in the drawing).

The exhaust collection part 402b of the exhaust pipe 402 is provided with an air-fuel ratio sensor 421. The air-fuel ratio sensor 421 is a sensor which senses an air-fuel ratio of the exhaust gas flowing in the flow passage in the exhaust collection part 402b and transforms the air-fuel ratio into an electric signal and outputs the electric signal. Further, the exhaust pipe 402 is provided with a catalyst 422 on the downstream side of a portion thereof in which the air-fuel ratio sensor 421 is provided. The catalyst 422 is a three-way catalyst for cleaning the exhaust gas.

The internal combustion engine 20 constructed in a manner described above is controlled by the ECU 1. The ECU 1 is electrically connected to the air flow meter 411 and the air-fuel ratio sensor 421 and receives the electric signals from each of them and processes the electric signals. Further, the ECU 1 is electrically connected also to the throttle valve 412, the fuel injector 206, the ignition plug 207, and the actuators 213, 214 and transmits a control signal to each of them to thereby control each of them.

The ECU 1 regulates an opening of the throttle valve 412 to thereby regulate the flow rate of the air to be supplied to the combustion chamber 201a of each of the cylinders 201 when the intake valve 201b is opened. Further, the ECU 1 injects the fuel into the combustion chamber 201a by the fuel injector 206 to thereby generate an air-fuel mixture of the atomized fuel and the air and makes the ignition plug 207 perform a spark discharge to thereby ignite the air-fuel mixture. Still further, the ECU 1 senses a crank angle and a rotation speed of an output shaft of the internal combustion engine 20 on the basis of a signal of the crank angle sensor 208.

A portion or all of the ECU 1 is constructed of an analog circuit or as a digital processor provided with a memory. In either case, in order to fulfil a function to output the control signal on the basis of the received electric signal, the ECU 1 has functional control blocks constructed therein.

FIG. 2 shows the ECU 1 as a functional control block diagram. In this regard, the analog circuit or a module of software built in the digital processor, which constructs the ECU 1, is not always required to be divided into control blocks shown in FIG. 2. In other words, the analog circuit or the like may be constructed as a part to play a plurality of control blocks or may be further subdivided. If the ECU 1 is constructed in such a way as to perform a processing flow to be described later, an actual construction of an interior of the ECU 1 can be appropriately modified by a person skilled in the art.

As shown in FIG. 2, the ECU 1 is provided with functional control blocks of an all-cylinder operation execution part 101, a cylinder-cut operation execution part 102, an operation shift part 103, an operation state determination part 104, a sensed information acquisition part 105, an air-fuel ratio estimation part 106, and a fuel correction part 107.

The all-cylinder operation execution part 101 is a part which makes the internal combustion engine 20 execute “an all-cylinder operation” to drive all cylinders 201 of the first cylinder #1, the second cylinder #2, the third cylinder #3, and the fourth cylinder #4. In this “all-cylinder operation”, the intake valves 201b and the exhaust valves 201c of all cylinders 201 are opened and closed by cams 211a, 212a which are rotated with the camshafts 211, 212. In this way, the fuel is combusted in all cylinders 201. Hence, the exhaust gas exhausted from all cylinders 201 flows in the exhaust collection part 402b of the exhaust pipe 402.

The cylinder-cut operation execution part 102 is a part which, in a case where an operation of the internal combustion engine 20 satisfies a predetermined condition, makes the internal combustion engine 20 execute “a cylinder-cut operation” which rests the second cylinder #2 and the third cylinder #3 and which operates the first cylinder #1 and the fourth cylinder #4. In other words, in a case where the internal combustion engine 20 executes the cylinder-cut operation, the number of cylinders 201 to be operated is reduced as compared with a case where the internal combustion engine 20 executes the all-cylinder operation. In this cylinder-cut operation, only the intake valves 201b and the exhaust valves 201c of the first cylinder #1 and the fourth cylinder #4 are opened and closed by cams 211a, 212a which are rotated with the camshafts 211, 212. On the other hand, the intake valves 201b and the exhaust valves 201c of the second cylinder #2 and the third cylinder #3 are pressed by actuators 213, 214, thereby being brought into a state where those intake valves 201b and exhaust valves 201c are inhibited from being opened and closed. In this way, the intake valves 201b and the exhaust valves 201c of the second cylinder #2 and the third cylinder #3 are held in a state where they close the intake ports 204 and the exhaust ports 205 of the second cylinder #2 and the third cylinder #3. In this way, the fuel is combusted only in the first cylinder #1 and the fourth cylinder #4 and only the exhaust gas exhausted from the first cylinder #1 and the fourth cylinder #4 flows in the exhaust pipe 402.

In this regard, in the present embodiment, it is assumed that the second cylinder #2 and the third cylinder #3 are rested in the cylinder-cut operation but the present disclosure is not limited to this. For example, it is also possible to rest the first cylinder #1 and the fourth cylinder #4 in the cylinder-cut operation.

The operation shift part 103 is a part which shifts an operation state of the internal combustion engine 20 from the all-cylinder operation to the cylinder-cut operation, or from the cylinder-cut operation to the all-cylinder operation. When the operation shift part 103 shifts the operation state of the internal combustion engine 20 from the all-cylinder operation to the cylinder-cut operation, the operation shift parts 103 rests the operation in sequence from the ready cylinders 201 of the second cylinder #2 and the third cylinder #3. Further, when the operation shift part 103 shifts the operation state of the internal combustion engine 20 from the cylinder-cut operation to the all-cylinder operation, the operation shift parts 103 restarts the operation in sequence from the ready cylinders 201 of the second cylinder #2 and the third cylinder #3.

The operation state determination part 104 is a part which determines which of a state where the internal combustion engine 20 is executing the all-cylinder operation, a state where the internal combustion engine 20 is executing the cylinder-cut operation, and a state where the internal combustion engine 20 is shifting to one of the all-cylinder operation and the cylinder-cut operation, the internal combustion engine 20 is in.

The sensed information acquisition part 105 is a part which acquires information, which is sensed respectively by the air flow meter 411, the air-fuel ratio sensor 421, and the crank angle sensor 208, at a specified timing.

The air-fuel ratio estimation part 106 is a part which estimates an air-fuel ratio of each of the cylinders 201 on the basis of the information sensed by the air-fuel ratio sensor 421.

The fuel correction part 107 is a part which corrects a flow rate of the fuel injected from the fuel injector 206 by appropriately using a determination result of the operation state in the operation state determination part 104 and an estimated value of the air-fuel ratio by the air-fuel ratio estimation part 106.

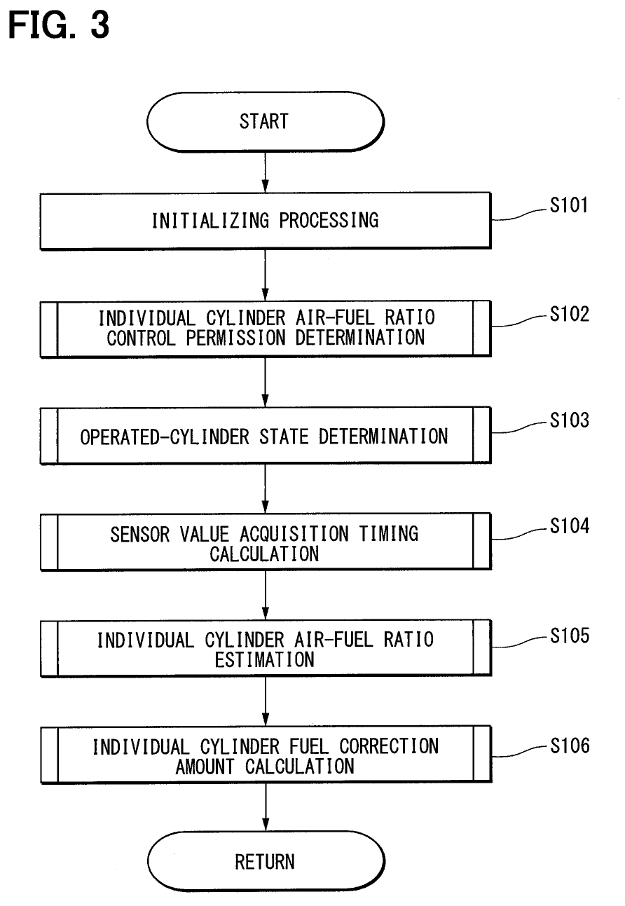

Next, a control processing of the internal combustion engine 20 by the ECU 1 will be described with reference to FIG. 3 to FIG. 13. In this regard, for simplification, the following description will be made on the assumption that also processing performed in detail by respective parts of the all-cylinder operation execution part 101 and the like of the ECU 1 will be performed in the lump by the ECU 1.

The ECU 1 performs the processing according to a base routine shown in FIG. 3 while the ECU 1 is energized (while an ignition switch of the vehicle is on). First, in step S101, the ECU1 performs an initializing processing routine to thereby initialize a control program. Then, the ECU 1 repeatedly performs respective subroutines from step S102 to step S106 at a predetermined period (for example, at a period of 1 msec).

### [Individual Cylinder Air-Fuel Ratio Control Permission Determination Routine]

First, in step S102 of FIG. 3, the ECU 1 performs an individual cylinder air-fuel ratio control permission determination routine. The individual cylinder air-fuel ratio control permission determination routine is a routine which determines whether or not the internal combustion engine 20 is in an operation state in which an estimation of the air-fuel ratio of each of the cylinders 201 can be permitted.

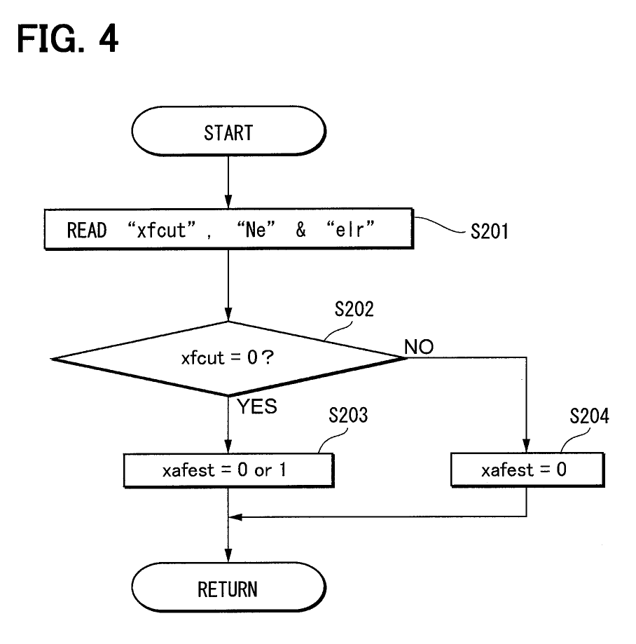

The individual cylinder air-fuel ratio control permission determination routine will be described in detail with reference to FIG. 4. The individual cylinder air-fuel ratio control permission determination routine is performed at a predetermined period (for example, at a period of 30 CA (Crank Angle)).

First, in step S201, the ECU 1 reads a fuel cut execution flag “xfcut”, an internal combustion engine speed Ne, and an internal combustion engine load rate “elr”. The fuel cut execution flag “xfcut” is a flag to which “1” is set only in a case where a fuel supply is stopped to all of the cylinders 201 (fuel cut), for example, in a case where the vehicle is reducing speed. In other words, as in a case where the internal combustion engine 20 is executing the cylinder-cut operation, in a case where the fuel cut is executed for only a part of the cylinders 201, “1” is not set to the fuel cut execution flag “xfcut”.

Next, in step S202, the ECU 1 determines whether or not the fuel cut execution flag “xfcut” is “0”. In other words, the ECU 1 determines whether or not a fuel cut for all of the cylinders is executed in the internal combustion engine 20.

In a case where it is determined in step S202 that the fuel cut execution flag “xfcut” is “0” (step S202: YES), that is, in a case where it is determined that the fuel cut for all of the cylinders is not executed, the routine proceeds to step S203.

Next, in step S203, the ECU 1 compares a previously prepared map with the internal combustion engine speed Ne and the internal combustion engine load rate “elr”, which are read in step S201, and sets “0” or “1” to an individual cylinder air-fuel ratio control permission determination flag “xafest” on the basis of a comparison result. The map has the internal combustion engine speed Ne and the internal combustion engine load rate “elr” as parameters and shows the operation state of the internal combustion engine 20.

In general, in a case where the flow rate of the exhaust gas flowing in the flow passage in the exhaust pipe 402 is small, an air-fuel ratio of each of the cylinders 201 cannot be estimated correctly. In step S203, in a case where a combination of the internal combustion engine speed Ne and the internal combustion engine load rate “elr”, which are read in step S201, satisfies a predetermined condition, it is assumed that the exhaust gas of a flow rate in which the air-fuel ratio can be estimated correctly flows in the flow passage in the exhaust pipe 402 and “1” is set to the individual cylinder air-fuel ratio control permission determination flag “xafest”, whereas in other case, “0” is set to the individual cylinder air-fuel ratio control permission determination flag “xafest”. This is because while the fuel cut is executed, the fuel is not injected and hence the air-fuel ratio cannot be estimated and because in the first place, while the fuel cut is executed, the air-fuel ratio does not need to be estimated.

On the other hand, in a case where it is determined in step S202 that the fuel cut execution flag “xfcut” is not “0” (step S202: NO), that is, in a case where it is determined that the fuel cut for all of the cylinders 201 is executed, the routine proceeds to step S204.

Next, in step S204, the ECU 1 sets “0” to the individual cylinder air-fuel ratio control permission determination flag “xafest”.

### [Operated-Cylinder State Determination Routine]

The ECU 1 which finishes performing the individual cylinder air-fuel ratio control permission determination routine, next, in step S103 of FIG. 3, performs an operated-cylinder state determination routine. The operated cylinder state determination routine is a subroutine for determining whether the internal combustion engine 20 is executing the all-cylinder operation or is executing the cylinder-cut operation and for determining whether or not the internal combustion engine 20 is in a state where a correction of an amount of fuel to be supplied can be made.

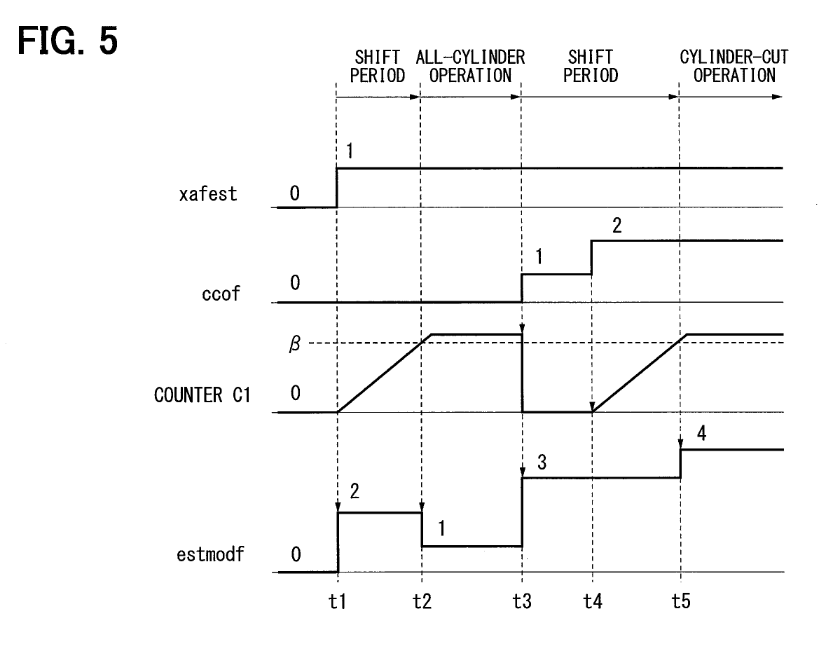

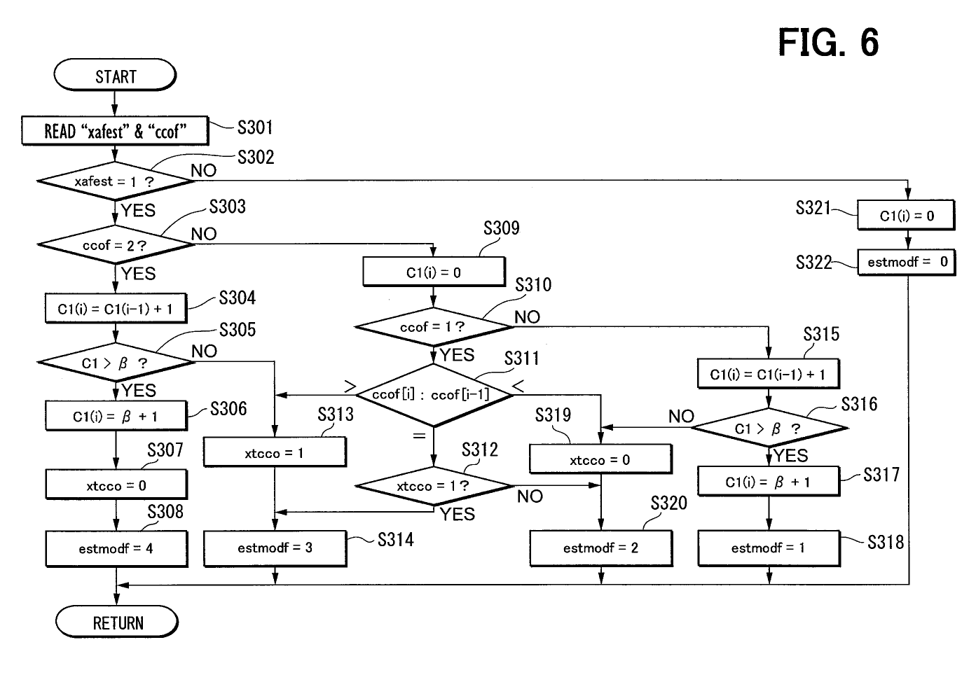

The operated cylinder state determination routine will be described with reference to FIG. 5 and FIG. 6. The operated cylinder state determination routine is performed at a predetermined period (for example, at a period of 30 CA (Crank Angle)). First, an outline of the operated cylinder state determination routine will be described with reference to FIG. 5.

When the internal engine 20 is being operated, the ECU 1 calculates a cylinder-cut operation phase signal “ccof” as needed. The cylinder-cut operation phase signal “ccof” is a signal to indicate an operation phase of the internal combustion engine 20. Specifically, in the cylinder-cut operation phase signal “ccof”, “0” indicates that all of the cylinders 201 are operated. Further, in the cylinder-cut operation phase signal “ccof”, “1” indicates that the second cylinder #2 is rested and that the other cylinders 201 are operated. Still further, in the cylinder-cut operation phase signal “ccof”, “2” indicates that the second cylinder #2 and the third cylinder #3 are rested and that the other cylinders are operated. It is assumed that when the cylinder-cut operation phase signal “ccof” shifts from one of “0” and “2” to the other, the cylinder-cut operation phase signal “ccof” always passes “1”.

Further, the ECU 1 calculates an operated cylinder state phase signal “estmodf” as needed. The operated cylinder state phase signal “estmodf” is a signal calculated by the use of a counter C1. The counter C1 counts up on the basis of an elapse of time.

An output value of the air-fuel ratio sensor 421 causes a response delay caused by its performance. Further, it takes time for the exhaust gas exhausted from each of the cylinders 201 to reach the exhaust collection part 402b in which the air-fuel ratio sensor 421 is provided. Hence, also a period of time during which the exhaust gas flows causes a response delay in the output value of the air-fuel ratio sensor 421. In order to correctly estimate the air-fuel ratio in consideration of the response delays like this and to surely employ the estimated air-fuel ratio in operations after the present subroutine, the ECU 1 makes a determination using the counter C1.

In a case where all execution conditions of an individual cylinder air-fuel ratio control are satisfied at a time t1 when the internal combustion engine 20 is executing the all-cylinder operation, the ECU 1 sets “1” to the individual cylinder air-fuel ratio control permission determination flag “xafest” which has been set to “0”. When “1” is set to the individual cylinder air-fuel ratio control permission determination flag “xafest”, the counter C1 starts to count up.

In a case where a count value of the counter C1 is less than a threshold value β and where the cylinder-cut operation phase signal “ccof” indicates “0”, the operated cylinder state phase signal “estmodf” indicates “2”. When the count value of the counter C1 becomes not less than the threshold value β at a time t2, it is determined that a time sufficient to perform the individual cylinder air-fuel ratio control passes and “1” is set to the operated cylinder state phase signal “estmodf”. Here, the threshold value is a value obtained previously by an experiment in the drive system shown in FIG. 1.

When the internal combustion engine 20 starts to shift from the all-cylinder operation to the cylinder-cut operation at a time t3, the cylinder-cut operation phase signal “ccof” is switched from “0” to “1”. At this timing, the ECU 1 determines that this is a timing when the internal combustion engine 20 shifts from the all-cylinder operation to the cylinder-cut operation and resets the count value of the counter C1 and sets “3” to the operated cylinder state phase signal “estmodf”.

When the cylinder-cut operation phase signal “ccof” indicates “2” and the internal combustion engine 20 completely finishes shifting to the cylinder-cut operation at a time t4, the counter C1 starts to count up. In a case where the count value of the counter C1 is less than the threshold value β, the ECU 1 determines that the air-fuel ratio sensor 421 does not yet sense the exhaust gas after the internal combustion engine 20 shifts to the cylinder-cut operation and holds the operated cylinder state phase signal “estmodf” set to “3”.

When the counter value of the counter C1 becomes not less than the threshold value β at a time t5, the ECU 1 determines that a time sufficient to perform the individual cylinder air-fuel ratio control passes and sets “4” to the operated cylinder state phase signal “estmodf”.

Here, “all-cylinder operation” and the like shown in the uppermost place of FIG. 5 show that the air-fuel ratio sensed by the air-fuel ratio sensor 421 at that timing is the air-fuel ratio of the exhaust gas exhausted when the internal combustion engine 20 is in which operation state. For example, between a time t4 and a time t5, the cylinder-cut operation phase signal “ccof” indicates “2” and hence the internal combustion engine 20 is in a state in which the internal combustion engine 20 rests two cylinders 201 already and hence is executing the cylinder-cut operation. However, since the output value of the air-fuel ratio sensor 421 causes the response delay as described above, the air-fuel ratio sensed by the air-fuel ratio sensor 421 between the time t4 and the time t5 is still the air-fuel ratio of the exhaust gas exhausted when the internal combustion engine 20 is shifting to the cylinder-cut operation, so that in the uppermost place of FIG. 5 is shown “a shift period to the cylinder-cut operation”.

Next, a flow of processing in the operated cylinder state determination routine will be described with reference to FIG. 6.

First, in step S301, the ECU 1 reads the individual cylinder air-fuel ratio control permission determination flag “xafest” and the cylinder-cut operation phase signal “ccof”. After reading them, next, the ECU 1 proceeds to step S302.

Next, in step S302, the ECU 1 determines whether or not the individual cylinder air-fuel ratio control permission determination flag “xafest” is “1”. In other words, the ECU 1 determines whether or not the operation state of the internal combustion engine 20 is in a state in which the individual cylinder air-fuel ratio control can be permitted. In a case where the operation state of the internal combustion engine 20 is in the state in which the individual cylinder air-fuel ratio control can be permitted (S302: YES), next, the ECU 1 proceeds to step S303.

Next, in step S303, the ECU 1 determines whether or not the cylinder-cut operation phase signal “ccof” is “2”. In other words, the ECU 1 determines whether or not the internal combustion engine 20 is in a state where of four cylinders 201 of the internal combustion engine 20, two cylinders 201 are rested and the other cylinders are operated. In a case where the internal combustion engine 20 is in this state (S303: YES), next, the ECU 1 proceeds to step S304.

Next, in step S304, the ECU 1 makes the counter C1 count up the count value by “1”. After the counter C1 counts up, next, the ECU 1 proceeds to step S305.

Next, in step S305, the ECU 1 determines whether or not the count value of the counter C1 is more than the threshold value β. In a case where the count value of the counter C1 is more than the threshold value β (S305: YES), the ECU 1 determines that after the internal combustion engine 20 shifts to the cylinder-cut operation, a time sufficient for the air-fuel ratio sensor 421 to be able to sense a correct air-fuel ratio passes and then proceeds to a next step S306.

Next, in step S306, the ECU 1 sets “β+1” to the count value of the counter C1, thereby avoiding the counter C1 from being reset because of an overflow. After setting “β+1” to the count value of the counter C1, next, the ECU 1 proceeds to step S307.

Next, in step S307, the ECU 1 sets “0” to a cylinder-cut shift period flag “xtcco”. “0” set to the cylinder-cut shift period flag “xtcco” means that a shift period during which the internal combustion engine 20 shifts to the cylinder-cut operation is finished. After setting “0” to the cylinder-cut shift period flag “xtcco”, next, the ECU 1 proceeds to step S308.

Next, in step S308, the ECU 1 sets “4” to the operated cylinder state phase signal “estmodf”. In other words, the ECU 1 determines that a time sufficient to perform the individual cylinder air-fuel ratio control passes and sets “4” to the operated cylinder state phase signal “estmodf”.

On the other hand, in a case where it is determined in step S03 that the cylinder-cut operation phase signal “ccof” is not “2” (S303: NO), the ECU 1 determines that the internal combustion engine 20 is not executing the cylinder-cut operation and proceeds to step S309.

Next, in step S309, the ECU 1 resets the counter value of the counter C1. After resetting the counter value of the counter C1, next, the ECU 1 proceeds to step S310.

Next, in step S310, the ECU 1 determines whether or not the cylinder-cut operation phase signal “ccof” is “1”. In other words, the ECU 1 determines whether or not the internal combustion engine 20 rests one cylinder 201 and operates the other cylinders 201, that is, is shifting to the cylinder-cut operation from the all-cylinder operation. When the internal combustion engine 20 is shifting to the cylinder-cut operation or the all-cylinder operation, the operation state of the internal combustion engine 20 is in a transient state, so that information related to an appropriate air-fuel ratio cannot be acquired by the air-fuel ratio sensor 421. In a case where the internal combustion engine 20 is shifting to the cylinder-cut operation or the all-cylinder operation (S310: YES), next, the ECU 1 proceeds to step S311.

Next, in step S311, the ECU 1 compares a magnitude between a value of the present time of the cylinder-cut operation phase signal “ccof” with a value of the last time of the cylinder-cut operation phase signal “ccof”. In a case where it is determined in this step S311 that the value of the present time of the cylinder-cut operation phase signal “ccof” is larger than the value of the last time of the cylinder-cut operation phase signal “ccof” (S311: >), the ECU 1 determines that the internal combustion engine 20 starts to shift from the all-cylinder operation to the cylinder-cut operation and proceeds to step S313.

Next, in step S313, the ECU 1 sets “1” to the cylinder-cut shift period flag “xtcco”. After setting “1” to the cylinder-cut shift period flag “xtcco”, next, the ECU 1 proceeds to step S314.

Next, in step S314, the ECU 1 sets “3” to the operated cylinder state phase signal “estmodf”. This value is a value to mean that the internal combustion engine 20 is shifting to the cylinder-cut operation.

On the other hand, it is determined in step S311 that the value of the present time of the cylinder-cut operation phase signal “ccof” is equal to the value of the last time of the cylinder-cut operation phase signal “ccof” (S311: =), it can be determined that the internal combustion engine 20 is shifting to the all-cylinder operation or the cylinder-cut operation. In this case, next, the ECU 1 proceeds to step S312.

Next, in step S312, the ECU 1 determines whether or not the cylinder-cut shift period flag “xtcco” is “1”. In a case where it is determined that the cylinder-cut shift period flag “xtcco” is “1” (S312: YES), next, the ECU 1 proceeds to step S314, and as described above, in step S314, the ECU 1 sets “3” to the operated cylinder state phase signal “estmodf”.

On the other hand, in a case where it is determined in step S312 that the cylinder-cut shift period flag “xtcco” is not “1” (S321: NO), it is determined that the internal combustion engine 20 is shifting from the cylinder-cut operation to the all-cylinder operation and then the ECU 1 proceeds to step S320.

Next, in step S320, the ECU 1 sets “2” to the operated cylinder state phase signal “estmodf”. This means that the internal combustion engine 20 is shifting to the all-cylinder operation.

On the other hand, in a case where it is determined in step S311 that the value of the present time of the reduced cylinder state phase signal “ccof” is smaller than the value of the last time of the reduced cylinder state phase signal “ccof” (S311: <), it can be determined that this is a timing when the internal combustion engine 20 starts to shift from the cylinder-cut operation to the all-cylinder operation. In this case, next, the ECU 1 proceeds to step S319.

Next, in step S319, the ECU 1 sets “0” to the cylinder-cut shift period flag “xtcco”. “0” set to the cylinder-cut shift period flag “xtcco” means that this is a timing when the internal combustion engine 20 is switched to a shift period from the cylinder-cut operation to the all-cylinder operation. After setting “0” to the cylinder-cut shift period flag “xtcco”, the ECU 1 proceeds to step S320 and performs the same processing as described above.

On the other hand, in a case where it is determined in step S310 that the cylinder-cut operation phase signal “ccof” is not “1” (S310: NO), that is, in a case where the cylinder-cut operation phase signal “ccof” is “0” and that it is determined that the internal combustion engine 20 is executing the all-cylinder operation, next, the ECU 1 proceeds to step S315.

Next, in step S315, the ECU 1 counts up the count value of the counter C1 by “1”. After counting up, next, the ECU 1 proceeds to step S316.

Next, in step S316, the ECU 1 determines whether or not the count value of the counter C1 is more than the threshold value β. In a case where the count value is more than the threshold value p (S316: YES), the ECU 1 determines that after the internal combustion engine 20 shifts to the cylinder-cut operation, a time sufficient for the air-fuel ratio sensor 421 to be able to sense a correct air-fuel ratio passes and then proceeds to the next step S317.

Next, in step S317, the ECU 1 sets “β+1” to the count value of the counter C1, thereby avoiding the counter C1 from being reset by an overflow. After setting “β+1” to the count value of the counter C1, next, the ECU 1 proceeds to step S318.

Next, in step S318, the ECU 1 sets “1” to the operated cylinder state phase signal “estmodf”. In other words, the ECU 1 determines that the time sufficient to perform the individual cylinder air-fuel ratio control passes, and hence sets “1” to the operated cylinder state phase signal “estmodf”.

Further, in a case where it is determined in step S316 that the count value of the counter C1 is not more than the threshold value 13 (S316: NO), the ECU 1 determines that a time sufficient for the air-fuel ratio sensor 421 to sense a correct air-fuel ratio does not pass and then proceeds to step S319. The ECU 1 performs the same processing as described above after step S319.

Further, in a case where it is determined in step S305 that the count value of the counter C1 is not more than the threshold value 13 (S305: NO), it can be estimated that although the internal combustion engine 20 shifts to the cylinder-cut operation, a time sufficient for the air-fuel ratio sensor 421 to sense a correct air-fuel ratio does not pass. Hence, in this case, next, the ECU 1 proceeds to step S313. The ECU 1 performs the same processing as described above after step S313.

In contrast to this, in a case where it is determined in step S302 that the ECU 1 determines that the individual cylinder air-fuel ratio control permission determination flag “xafest” is not “1” (S302: NO), the ECU 1 determines that the operation state of the internal combustion engine 20 is not in a state in which the individual cylinder air-fuel ratio control can be permitted and then proceeds to a next step S321.

Next, in step S321, the ECU 1 resets the count value of the counter C1. After resetting the counter value of the counter C1, next, the ECU 1 proceeds to step S322.

Next, in step S322, the ECU 1 sets “0” to the operated cylinder state phase signal “estmodf”. This means that the individual cylinder air-fuel ratio control is not permitted”.

### [Sensor Value Acquisition Timing Calculation Routine]

The ECU 1 that finishes performing the operated cylinder state determination routine, next, in step S104 of FIG. 3, performs a sensor value acquisition timing calculation routine. The sensor value acquisition timing calculation routine is a subroutine that calculates a timing when a value related to the air-fuel ratio of the exhaust gas is acquired by the air-fuel ratio sensor 421.

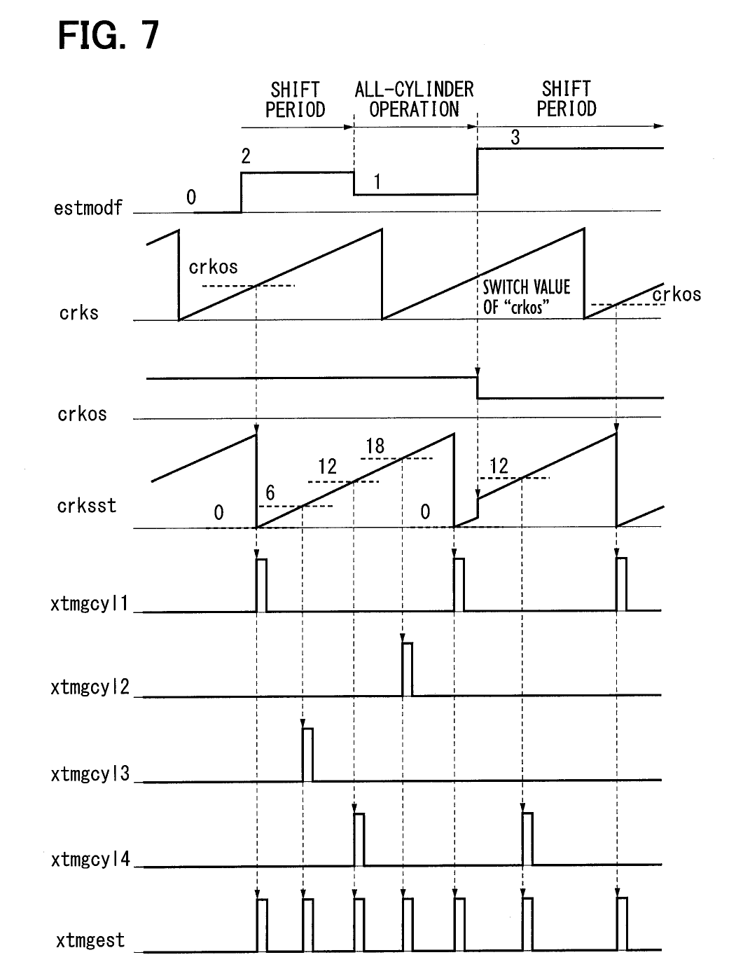

The sensor value acquisition timing calculation routine will be described in detail with reference to FIG. 7 to FIG. 9. The sensor value acquisition timing calculation routine is performed at a predetermined period (for example, at a period of 30 CA (Crank Angle)). First, an outline of the operated cylinder state determination routine will be described with reference to FIG. 7.

The ECU 1 maps and holds a crank signal “crks” of a timing when an air-fuel ratio of the first cylinder #1 is indicated as the output value of the air-fuel ratio sensor 421 for each operating condition. The ECU 1 makes a standard crank signal “crksst”, which is reset at a timing when a crank offset value “crkos” is reached, on the basis of the crank signal “crks” which is counted up from 0 to 23 at a period of 30° CA.

At timings when the standard crank signal “crksst” indicates “0”, “6”, “12”, and “18”, the ECU 1 sets “1” to a first cylinder timing determination flag “xtmgcyl1”, a second cylinder timing determination flag “xtmgcyl2”, a third cylinder timing determination flag “xtmgcyl3”, and a fourth cylinder timing determination flag “xtmgcyl4”. Further, the ECU 1 sets “1” to an air-fuel ratio sensor value acquisition flag “xtmgest” at a timing when any of the cylinder timing determination flags is established.

Here, the characteristics of the exhaust gas and the response characteristics of the air-fuel ratio sensor 421 are different between when the internal combustion engine 20 is executing the cylinder-cut operation and when the internal combustion engine 20 is executing the all-cylinder operation. Hence, when the internal combustion engine 20 is executing the cylinder-cut operation, the ECU 1 refers to a map different from a map when the internal combustion engine 20 is executing the all-cylinder operation and switches a value of the crank offset value “crkos”. Further, when the internal combustion engine 20 is executing the cylinder-cut operation, the ECU 1 acquires an air-fuel ratio sensor value at a timing when only an air-fuel ratio of the cylinder 201, which is operated, is indicated as an output value of the air-fuel ratio sensor 421, so that the ECU 1 does not set “1” to the timing determination flag corresponding to the cylinder 201 which is rested.

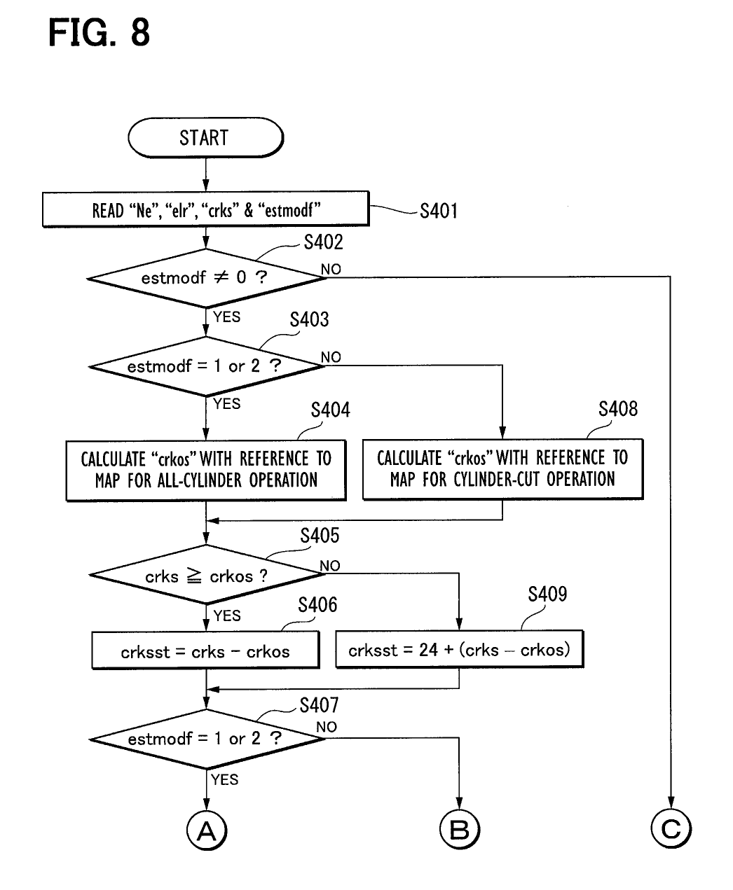

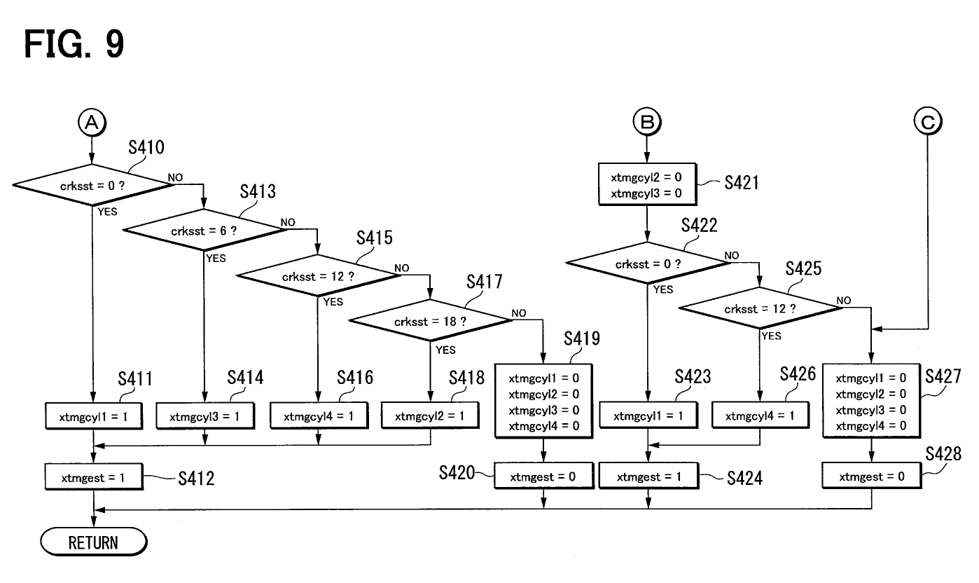

Next, a flow of processing in the sensor value acquisition timing calculation routine will be described with reference to FIG. 8 and FIG. 9.

First, in step S401, the ECU 1 reads the internal combustion engine speed Ne, the internal combustion engine load rate “elr”, the crank signal “crks”, and the operated cylinder state phase signal “estmodf”. After reading these, next, the ECU 1 proceeds to step S402.

Next, in step S402, the ECU 1 determines whether or not the operated cylinder state phase signal “estmodf” is different from “0”. In a case where the operated cylinder state phase signal “estmodf” is different from “0” (S402: YES), the ECU 1 determines that the individual cylinder air-fuel ratio control is permitted and, next, proceeds to step S403.

Next, in step S403, the ECU 1 determines whether the operated cylinder state phase signal “estmodf” is “1” or “2”. A state where “1” is set to the operated cylinder state phase signal “estmodf” indicates a state where the internal combustion engine 20 is executing the all-cylinder operation. Further, a state where “2 is set to the operated cylinder state phase signal “estmodf” indicates a state where the internal combustion engine 20 is shifting to the all-cylinder operation. In a case where the operated cylinder state phase signal “estmodf” is “1” or “2” (S403: YES), next, the ECU 1 proceeds to step S404.

Next, in step S404, the ECU 1 calculates the crank offset value “crkos” with reference to the map for the all-cylinder operation which is described above. The map has parameters of the internal combustion engine speed Ne and the internal combustion engine load rate “elr” and holds a value of the crank signal “crks” at a timing when the air-fuel ratio of the first cylinder #1 is indicated as the output value of the air-fuel ratio sensor 421. After calculating the crank offset value “crkos”, next, the ECU 1 proceeds to step S405.

On the other hand, in a case where it is determined in step S403 that the operated cylinder state phase signal “estmodf” is not “1” or “2” (S403: NO), it can be determined that the internal combustion engine 20 is executing the cylinder-cut operation or is shifting to the cylinder-cut operation. In this case, next, the ECU 1 proceeds to step S408.

Next, in step S408, the ECU 1 calculates the crank offset value “crkos” with reference to the map for the cylinder-cut operation. The map also has parameters of the internal combustion engine speed Ne and the internal combustion engine load rate “elr” and holds a value of the crank signal “crks” at a timing when the air-fuel ratio of the first cylinder #1 is indicated as the output value of the air-fuel ratio sensor 421. After calculating the crank offset value “crkos”, next, the ECU 1 proceeds to step S405.

After calculating the crank offset value “crkos” in step S404 or step S408, the ECU 1 determines in step S405 whether or not a crank signal “crks” is not less than the crank offset value “crkos”. In a case where the crank signal “crks” is not less than the crank offset value “crkos” (S405: YES), next, the ECU 1 proceeds to step S406.

Next, in step S406, the ECU 1 calculates the standard crank signal “crksst” on the basis of a predetermined calculation equation. After calculating the standard crank signal “crksst”, next, the ECU 1 proceeds to step S407.

On the other hand, it is determined in step S405 that the crank signal “crks” is less than the crank offset value “crkos” (S405: NO), next, the ECU 1 proceeds to step S409.

Next, in step S409, the ECU 1 calculates the standard crank signal “crksst” on the basis of a predetermined calculation equation which is different from the predetermined calculation equation in step S406. Since the standard crank signal “crksst” is calculated in step S409 and in in step S406 by the different calculation equations, the standard crank signal “crksst” becomes a counter which is reset at a timing when the air-fuel ratio of the first cylinder #1 is indicated as the output value of the air-fuel ratio sensor 421 and which counts up from 0 to 23 at a period of 30 CA. After calculating the standard crank signal “crksst”, next, the ECU 1 proceeds to step S407.

Next, in step S407, as is the case with step S403, the ECU 1 determines whether the operated cylinder state phase signal “estmodf” is “1” or “2”. In a case where the operated cylinder state phase signal “estmodf” is “1” or “2” (S407: YES), next, the ECU 1 proceeds to step S410.

Next, in step S410, the ECU 1 determines whether or not the standard crank signal “crksst” is “0”. In a case where it is determined that the standard crank signal “crksst” is “0” (S410: YES), it can be determined that this timing is a timing when the output value of the air-fuel ratio sensor 421 indicates the air-fuel ratio of the first cylinder #1. In this case, next, the ECU 1 proceeds to step S411.

Next, in step S411, the ECU 1 sets “1” to the first cylinder timing determination flag “xtmgcyl1”. After setting “1” to the first cylinder timing determination flag “xtmgcyl1”, next, the ECU 1 proceeds to step S412.

Next, in step S412, the ECU 1 sets “1” to the air-fuel ratio sensor value acquisition flag “xtmgest”. This means that an estimation of the air-fuel ratio is permitted.

In contrast to this, in a case where it is determined in step S410 that the standard crank signal “crksst” is not “0”, next, the ECU 1 proceeds to step S413.

In step S413 to step S414, in step S415 to step S416, and in step S417 to step S418, the ECU 1 performs the same processing as in step S410 to step S411, respectively. It can be determined in each processing that this timing is a timing when the output value of the air-fuel ratio sensor 421 indicates the air-fuel ratio of each of the third cylinder #3, the fourth cylinder #4, or the second cylinder #2. Then, the ECU 1 sets “1” to each of the third cylinder timing determination flag “xtmgcyl3”, the fourth cylinder timing determination flag “xtmgcyl4”, and the second cylinder timing determination flag “xtmgcyl2”. Then, the ECU 1 proceeds to step S412 and performs the same processing as described above.

Incidentally, in a case where it is determined in step S417 that the standard crank signal “crksst” is not “18” (S417: NO), it can be determined that this timing is not a timing when the output value of the air-fuel ratio sensor 421 indicates the air-fuel ratio of each of the cylinders 201. In this case, next, the ECU 1 proceeds to step S419.

Next, in step S419, the ECU 1 performs a reset processing which sets “0” to each of the first cylinder timing determination flag “xtmgcyl1”, the second cylinder timing determination flag “xtmgcyl2”, the third cylinder timing determination flag “xtmgcyl3”, and the fourth cylinder timing determination flag “xtmgcyl4”. After executing the reset processing, next, the ECU 1 proceeds to step S420.

Next, in step S420, the ECU 1 sets “0” to the air-fuel ratio sensor value acquisition flag “xtmgest”. This means that the estimation of the air-fuel ratio is not permitted.

On the other hand, in a case where it is determined in step S407 that the operated cylinder state phase signal “estmodf” is not “1” or “2”, it can be determined that the internal combustion engine 20 is executing the cylinder-cut operation or is shifting to the cylinder-cut operation. In this case, next, the ECU 1 proceeds to step S421.

Next, in step S421, the ECU 1 sets “0” to the second cylinder timing determination flag “xtmgcyl2” and the third cylinder timing determination flag “xtmgcyl3”. Next, the ECU 1 proceeds to step S422.

Next, in step S422, as is the case with step S410, the ECU 1 determines whether or not the standard crank signal “crksst” is “0”. In a case where it is determined that the standard crank signal “crksst” is “0” (S422: YES), the processing in each of steps S423, S424 is the same as in each of steps S411, S412 described above.

On the other hand, in a case where it is determined in step S422 that the standard crank signal “crksst” is not “0” (S422: NO), next, the ECU 1 proceeds to step S425.

Next, in step S425, as is the case with step S415, the ECU 1 determines whether or not the standard crank signal “crksst” is “12”. In a case where it is determined that the standard crank signal “crksst” is “12” (S425: YES), the processing in each of steps S426, S424 is the same as in each of steps S416, S412 described above.

On the other hand, in a case where it is determined in step S425 that the standard crank signal “crksst” is not “12” (S425: NO), next, the ECU 1 proceeds to step S427. The processing in each of steps S427, S428 is the same as in each of steps S419, S420 described above.

Further, in a case where it is determined in step S402 that the operated cylinder state phase signal “estmodf” is different from “0” (S402: NO), next, the ECU 1 proceeds to step S427. The processing in each of steps S427, S428 is the same as in each of steps S419, S420 described above.

### [Individual Cylinder Air-Fuel Ratio Estimation Routine]

The ECU 1 which finishes performing the sensor value acquisition timing calculation routine, next, in step S105 of FIG. 3, performs an individual cylinder air-fuel ratio estimation routine. This individual cylinder air-fuel ratio estimation routine is a subroutine for estimating an air fuel ratio for each of the cylinders 201.

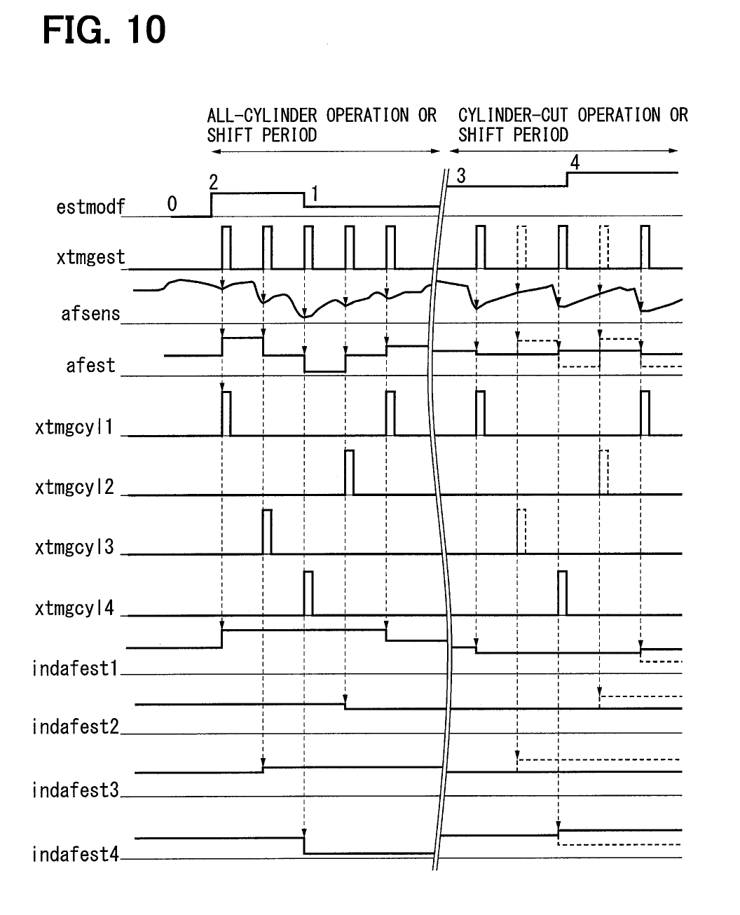

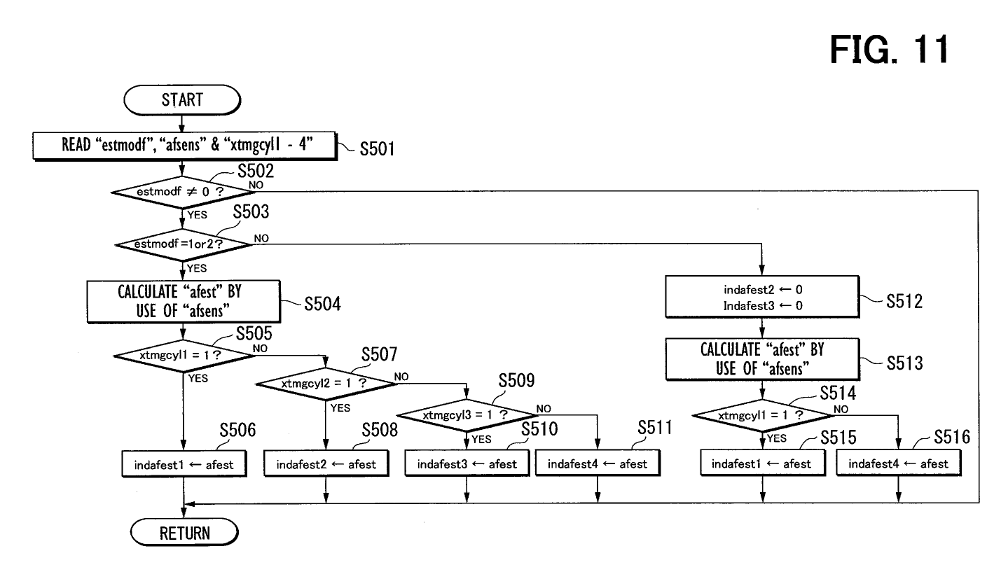

The individual cylinder air-fuel ratio estimation routine will be described in detail with reference to FIG. 10 and FIG. 11. First, an outline of the operated cylinder state determination routine will be described with reference to FIG. 10.

The ECU 1 acquires an output value of the air-fuel ratio sensor 421 at a timing when “1” is set to the air-fuel ratio sensor value acquisition flag “tmgest” and calculates an air-fuel ratio estimated value “afest”. Further, the ECU 1 calculates a first cylinder air-fuel ratio estimated value “indafest1”, a second cylinder air-fuel ratio estimated value “indafest2”, a third cylinder air-fuel ratio estimated value “indafest3”, and a fourth cylinder air-fuel ratio estimated value “indafest4” on the basis of the air-fuel ratio estimated value “afest” at a timing when “1” is set to any of the first cylinder timing determination flag “xtmgcyl1”, the second cylinder timing determination flag “xtmgcyl2”, the third cylinder timing determination flag “xtmgcyl3”, and the fourth cylinder timing determination flag “xtmgcyl4”.

Here, when the operated cylinder state phase signal “estmodf” is “3” or “4”, it can be determined that the internal combustion engine 20 is executing the cylinder-cut operation or is shifting to the cylinder-cut operation. In this case, the ECU 1 estimates an air-fuel ratio by using an observer different from an observer when the internal combustion engine 20 is executing the all-cylinder operation (, which will be described later).

A flow of processing in the operated cylinder state determination routine will be described with reference to FIG. 11.

First, in step S501, the ECU 1 reads the operated cylinder state phase signal “estmodf”, the air-fuel ratio sensor value “afsens”, the first cylinder timing determination flag “xtmgcyl1”, the second cylinder timing determination flag “xtmgcyl2”, the third cylinder timing determination flag “xtmgcyl3”, and the fourth cylinder timing determination flag “xtmgcyl4”. After reading them, next, the ECU 1 proceeds to step S502.

Next, in step S502, the ECU 1 determines whether or not the operated cylinder state phase signal “estmodf” is not “0”. In other words, the ECU 1 determines whether or not the individual cylinder air-fuel ratio control is permitted. In a case where the operated cylinder state phase signal “estmodf” is not “0” (S502: YES), it can be determined that the individual cylinder air-fuel ratio control is permitted. In this case, next, the ECU 1 proceeds to step S503.

Next, in step S503, the ECU 1 determines whether the operated cylinder state phase signal “estmodf” is “1” or “2”. As described above, a state where “1” is set to the operated cylinder state phase signal “estmodf” shows that the internal combustion engine 20 is executing the all-cylinder operation. Further, a state where “2” is set to the operated cylinder state phase signal “estmodf” shows that the internal combustion engine 20 is shifting to the all-cylinder operation. In a case where the operated cylinder state phase signal “estmodf” is “1” or “2” (S503: YES), next, the ECU 1 proceeds to step S504.

Next, in step S504, the ECU 1 calculates the air-fuel ratio estimated value “afest” by the use of the air-fuel ratio sensor value “afsens”. The air-fuel ratio estimated value “afest” is calculated by modeling the sensed value of the air-fuel ratio sensor value “afsens” by adding a value obtained by multiplying a history of the air-fuel ratio sensor value “afsens” by a predetermined weight to a value obtained by multiplying a history of the air-fuel ratio estimated value “afest” by another predetermined weight. Further, a Kalman filter is used as an observer. More specifically, the model will be described by the following formula f1. Here, “a1” to “a4” and “b1” to “b4” are constants each of which expresses a degree of weighting.

afsens(t)=a1*afsens(t−1)+a2*afsens(t−2)+a3*afsens(t−3)+a4*afsens(t−4)+b1*afest(t−1)+b2*afest(t−2)+b3*afest(t−2)+b4*afest(t−4) (f1)

A sensing delay caused by the air-fuel ratio sensor 421 includes a delay caused by the exhaust gas mixing with the exhaust gas exhausted from the past cylinder (the present air-fuel ratio is affected by the air-fuel ratio of the past cylinder) and a delay caused by the response of the air-fuel ratio sensor 421. Hence, in consideration of these delays, the formula f1 refers to the histories of the air-fuel ratio sensor value “afsens” and the air-fuel ratio estimated value “afest” of the last four times (values of the same cylinder 201 before 1 cycle).

When the formula f1 is transformed to a state space model by assuming that: “A”, “B”, “C”, “D” are parameters of the model; “afsens” is a sensed value of the air-fuel ratio sensor 421; “X” is an individual cylinder air-fuel ratio as a state variable; and “W” is noise, the following formula f2 can be obtained.

X(t+1)=AX(t)+B*afest(t)+W(t) afsens(t)=CX(t)+D*afest(t) (f2)

Further, when the Kalman filter is designed by assuming that: X̂ (x hat) expresses an individual cylinder air-fuel ratio as an estimated value; “K” expresses a Kalman gain; and an expression X̂ (k+1|k) expresses that an estimated value of a time “k+1” is found by an estimated value of a time “k”, the following formula f3 can be derived.

\hat{X}(k+1|k)=A\hat{X}(k|k−1)+K(Y(k)−CA\hat{X}(k|k−1)) (f3)

In this way, by estimating an air-fuel ratio by the use of a Kalman filter type observer, an air-fuel ratio can be estimated in sequence for each of the cylinders 201 along with a progress of a combustion stroke. In this regard, the above-described output “Y” is a deviation between the air-fuel ratio sensor value “afsens” and a target air-fuel ratio. The ECU 1 which finishes calculating the air-fuel ratio sensor value “afsens”, next, proceeds to step S505.

Next, in step S505, the ECU1 determines whether or not the first cylinder timing determination flag “xtmgcyl1” is “1”. In other words, the ECU 1 determines whether or not the air-fuel ratio estimated value “afest” of the first cylinder #1 is calculated, the air-fuel ratio estimated value “afest” of the first cylinder #1 compensating an effect of the past air-fuel ratio of the other cylinder 201 and the response delay of the air-fuel ratio sensor 421 from the output value of the air-fuel ratio sensor 421 at a timing when the air-fuel ratio of the first cylinder #1 is indicated. In a case where the first cylinder timing determination flag “xtmgcyl1” is “1” (S505: YES), next, the ECU 1 proceeds to step S506.

Next, in step S506, the ECU1 sets the value of the air-fuel ratio estimated value “afest” to the first cylinder air-fuel ratio estimated value “indafest1”.

On the other hand, in a case where it is determined in step S505 that the first cylinder timing determination flag “xtmgcyl1” is not “1” (S505: NO), next, the ECU 1 proceeds to step S507.

Next, in step S507, the ECU1 determines whether or not the second cylinder timing determination flag “xtmgcyl2” is “1”. In a case where it is determined that the second cylinder timing determination flag “xtmgcyl2” is “1” (S507: YES), next, the ECU 1 proceeds to step S508.

Next, in step S508, the ECU1 sets the value of the air-fuel ratio estimated value “afest” to the second cylinder air-fuel ratio estimated value “indafest2”.

On the other hand, in a case where it is determined in step S507 that the second cylinder timing determination flag “xtmgcyl2” is not “1” (S507: NO), next, the ECU 1 proceeds to step S509.

Next, in step S509, the ECU1 determines whether or not the third cylinder timing determination flag “xtmgcyl3” is “1”. In a case where it is determined that the third cylinder timing determination flag “xtmgcyl3” is “1” (S509: YES), next, the ECU 1 proceeds to step S510.

Next, in step S510, the ECU1 sets the value of the air-fuel ratio estimated value “afest” to the third cylinder air-fuel ratio estimated value “indafest3”.

On the other hand, in a case where it is determined in step S509 that the third cylinder timing determination flag “xtmgcyl3” is not “1” (S509: NO), next, the ECU 1 proceeds to step S511.

Next, in step S511, the ECU1 sets the value of the air-fuel ratio estimated value “afest” to the fourth cylinder air-fuel ratio estimated value “indafest4”.

In contrast to this, in a case where it is determined in step S502 that the operated cylinder state phase signal “estmodf” is “0”, it can be determined that the individual cylinder air-fuel ratio control is not permitted, so the processing is finished without performing any more action.

Further, in a case where it is determined in step S503 that the operated cylinder state phase signal “estmodf” is not “1” or “2”, it can be determined that the internal combustion engine 20 is executing the cylinder-cut operation or is shifting to the cylinder-cut operation. In this case, next, the ECU 1 proceeds to step S512.

Next, in step S512, the ECU 1 sets “0” to the second cylinder air-fuel ratio estimated value “indafest2” of the second cylinder #2 which is rested and to the third cylinder air-fuel ratio estimated value “indafest3” of the third cylinder #3 which is rested. After setting “0” to them, next, the ECU 1 proceeds to step S513.

Next, in step S513, the ECU 1 calculates the air-fuel ratio estimated value “afest” by using the air-fuel ratio sensor value “afsens”. The air-fuel ratio estimated value “afest” is calculated, as is the case with step S504, by modeling the sensed value of the air-fuel ratio sensor value “afsens” by adding a value obtained by multiplying a history of the air-fuel ratio sensor value “afsens” by a predetermined weight to a value obtained by multiplying a history of the air-fuel ratio estimated value “afest” by another predetermined weight. However, the internal combustion engine 20 is executing the cylinder-cut operation and the fuel is combusted in only two cylinders in 720° CA, so the construction of the modeling is changed.

When the internal combustion engine 20 is executing the all-cylinder operation, in consideration of the delay caused by the mixture of the exhaust gas and the delay caused by the response of the air-fuel ratio sensor 421, the histories of the air-fuel ratio sensor value “afsens” and the air-fuel ratio estimated value “afest” of the last four times are referred to. However, when the internal combustion engine 20 is executing the cylinder-cut operation, it is assumed that the histories of the air-fuel ratio sensor value “afsens” and the air-fuel ratio estimated value “afest” of the last two times (values of the same cylinder 201 before 1 cycle) are referred to. More specifically, the following formula f4 can be obtained. Here, “c1”, “c2”, “c3”, “c4” and “d1”, “d2” are constants to express the degree of weighting. Then, by transforming the formula f4 to a state space model in the same way and then by designing the Kalman filter, the air-fuel ratio can be estimated.

afsens(t)=c1*afsens(t−1)+c2*afsens(t−2)+d1*afest(t−1)+d2*afest(t−2) (f4)

Next, in step S514, the ECU1 determines whether or not the first cylinder timing determination flag “xtmgcyl1” is “1”. In a case where the first cylinder timing determination flag “xtmgcyl1” is “1” (S514: YES), next, the ECU 1 proceeds to step S515.

Next, in step S515, as is the case with step S506, the ECU1 sets the value of the air-fuel ratio estimated value “afest” to the first cylinder air-fuel ratio estimated value “indafest1”.

On the other hand, in a case where it is determined in step S514 that the first cylinder timing determination flag “xtmgcyl1” is not “1” (S514: NO), next, the ECU 1 proceeds to step S516.

Next, in step S516, the ECU1 sets the value of the air-fuel ratio estimated value “afest” to the fourth cylinder air-fuel ratio estimated value “indafest4”.

As described above, the ECU 1 estimates the air-fuel ratio by using the different observer between a case where the internal combustion engine 20 is executing the all-cylinder operation and a case where the internal combustion engine 20 is executing the cylinder-cut operation. It is assumed that, hypothetically, also in a case where the internal combustion engine 20 is executing the cylinder-cut operation, the ECU 1 estimates an air-fuel ratio by using the same observer as in a case where the internal combustion engine 20 is executing the all-cylinder operation. Then, a result in that case will be shown by dotted lines in FIG. 10.

In a case where the operated cylinder state phase signal “estmodf” is “3” or “4”, the internal combustion engine 20 is executing the cylinder-cut operation or is shifting to the cylinder-cut operation. In this case, an air-fuel ratio sensor value “afsens” indicated at a timing when an output value of the air-fuel ratio sensor 421 indicates an air-fuel ratio of each of the second cylinder #2 and the third cylinder #3, which are rested, is not an air-fuel ratio outputted by the combustion of the fuel in each of the second cylinder #2 and the third cylinder #3 but is an air-fuel ratio affected by an air-fuel ratio of the other cylinder 201 in which the fuel is combusted immediately before.

When the ECU 1 uses an observer constructed by an algorism to assume that the internal combustion engine 20 executes the all-cylinder operation also in a case where the internal combustion engine 20 is executing the cylinder-cut operation, the ECU 1 cannot estimate a suitable air-fuel ratio. In short, in spite of the fact that the second cylinder #2 and the third cylinder #3 are rested, the ECU 1 treats the air-fuel ratio sensor values “afsens” as the air-fuel ratios caused by the exhaust gas generated by the combustion of the fuel in the second cylinder #2 and the third cylinder #3, which results in calculating an erroneous air-fuel ratio estimated values “afest”. Further, as described above, the histories of the air-fuel ratio estimated value “afest” of the last times are used for estimating the air-fuel ratio, so that the erroneous air-fuel ratio sensor values “afsens” have an effect on the air-fuel ratios of the first cylinder #1 and the fourth cylinder #4, which are operated, and hence result in causing an erroneous result.

In contrast to this, the ECU 1 of the present embodiment reads the air-fuel ratio sensor value “afsens” only at timings when the air-fuel ratios of the exhaust gas of the first cylinder #1 and the fourth cylinder #4, which are operated, are indicated as the output values of the air-fuel ratio sensor 421 and estimates the air-fuel ratio.

Further, as described above, when the ECU 1 estimates the air-fuel ratio also in a case where the internal combustion engine 20 is executing the cylinder-cut operation by using the same observer as in a case where the internal combustion engine 20 is executing the all-cylinder operation, the ECU 1 refers to the histories of the air-fuel ratio sensor value “afsens” and the air-fuel ratio estimated value “afest” of the last four times. For this reason, in a state where only the first cylinder #1 and the fourth cylinder #4 are operated, the ECU 1 results in referring to the estimated air-fuel ratios before two cycles, so that the ECU 1 cannot correctly estimate the air-fuel ratio. Further, since the behavior of the air-fuel ratio are different between a case where the internal combustion engine 20 is executing the all-cylinder operation and a case where the internal combustion engine 20 is executing the cylinder-cut operation, when the ECU 1 estimates an air-fuel ratio when the internal combustion engine 20 is executing the cylinder-cut operation by using an observer made of model constants determined from the behavior of the air-fuel ratio when the internal combustion engine 20 is executing the all-cylinder operation, it is thought that an error will be made larger.

In contrast to this, when the internal combustion engine 20 is executing the cylinder-cut operation, the ECU 1 of the present embodiment uses a model construction which refers to the histories of the air-fuel ratio sensor value “afsens” and the air-fuel ratio estimated value “afest” of the last two times and estimates the air-fuel ratio by using the observer in which the constants of the model are determined from the behavior of the air-fuel ratio when the internal combustion engine 20 is executing the cylinder-cut operation. In this way, the estimation of the air-fuel ratio is not affected by the estimated air-fuel ratios of the second cylinder #2 and the third cylinder #3 which are rested. In other words, a suitable estimation of the air-fuel ratio can be made on the assumption that the second cylinder #2 and the third cylinder #3 are rested.

### [Individual Cylinder Fuel Correction Amount Calculation Routine]

The ECU 1 which finishes performing the operated cylinder state determination routine, next, in step S106 of FIG. 3, performs an individual cylinder fuel correction amount calculation routine. The individual cylinder fuel correction amount calculation routine is a subroutine for calculating a correction amount of the amount of the fuel to be supplied to each of the cylinders 201 (hereinafter also simply referred to as “a fuel correction amount”) in the individual cylinder air-fuel ratio control.

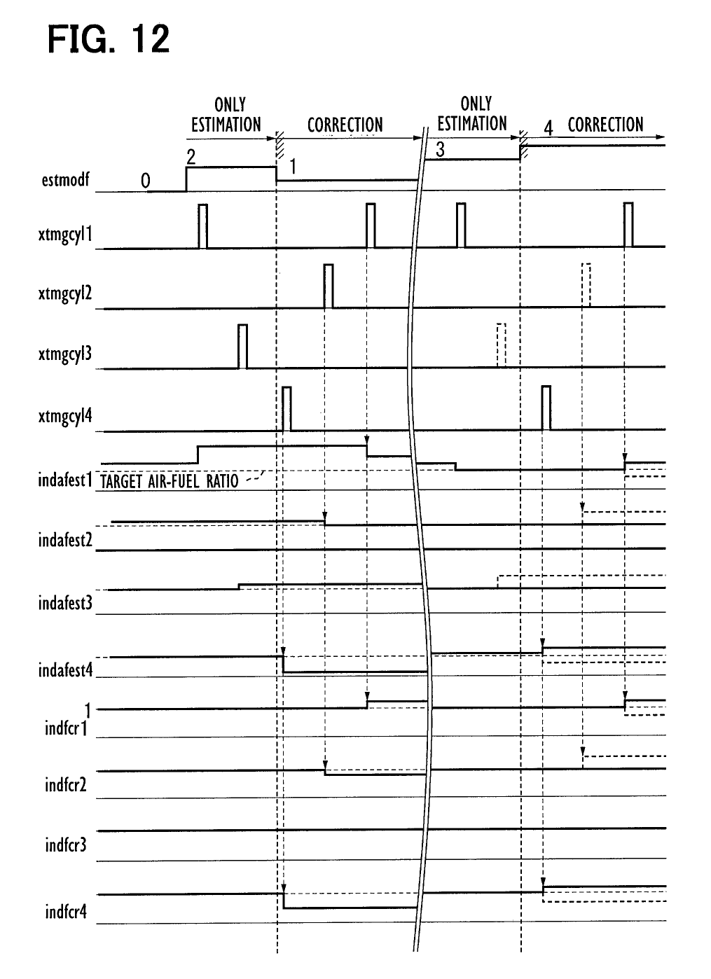

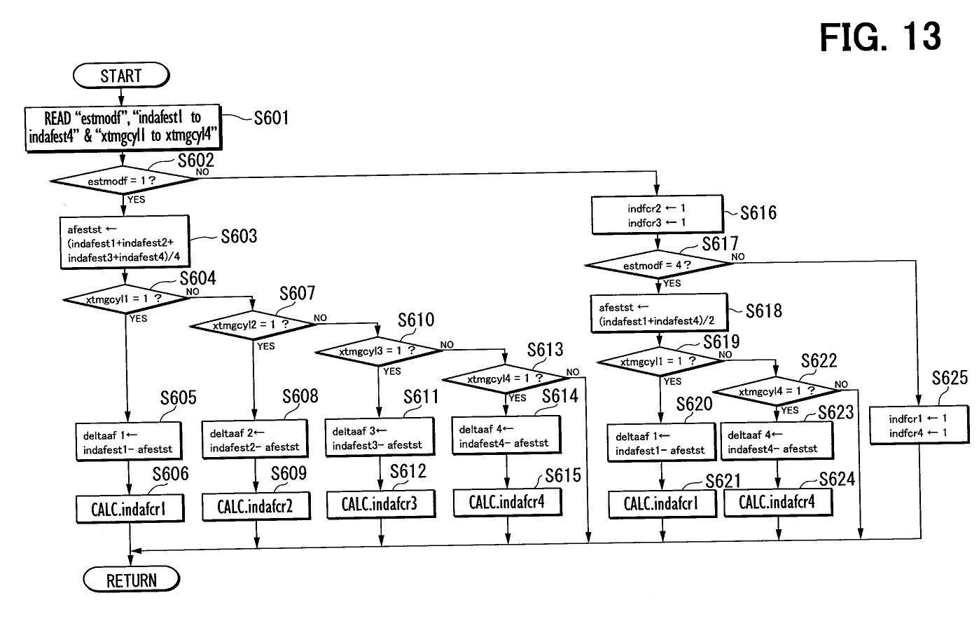

The individual cylinder fuel correction amount calculation routine will be described in detail with reference to FIG. 12 and FIG. 13. The individual cylinder fuel correction amount calculation routine is performed at a predetermined period (for example, at a period of 30 CA (Crank Angle). First, an outline of the individual cylinder fuel correction amount calculation routine will be described with reference to FIG. 12.

At a timing when “1” is set to any one of the first cylinder timing determination flag “xtmgcyl1”, the second cylinder timing determination flag “xtmgcyl2”, the third cylinder timing determination flag “xtmgcyl3”, and the fourth cylinder timing determination flag “xtmgcyl4”, the ECU 1 calculates a fuel correction amount on the basis of the first cylinder air-fuel ratio estimated value “indafest 1”, the second cylinder air-fuel ratio estimated value “indafest 2”, the third cylinder air-fuel ratio estimated value “indafest 3”, or the fourth cylinder air-fuel ratio estimated value “indafest 4” which corresponds to the cylinder 201 whose cylinder timing determination flag has “1” set thereto.

In a case where the operated cylinder state phase signal “estmodf” indicates “2”, the internal combustion engine 20 is shifting to the all-cylinder operation, so the ECU 1 does not calculate the fuel correction amount. Further, also in a case where the operated cylinder state phase signal “estmodf ” indicates “3”, the internal combustion engine 20 is shifting to the cylinder-cut operation, so the ECU 1 does not calculate the fuel correction amount.

The reason why in a case where the operated cylinder state phase signal “estmodf” indicates “2” or “3”, the air-fuel ratio is estimated in spite of the fact that the fuel correction amount is not calculated is that the calculated value of the air-fuel ratio need to be stored because the histories of the air-fuel ratio sensor value “afsens” and the histories of the air-fuel ratio estimated value “afest” of the last times are required to estimate the air-fuel ratio.

On the other hand, in a case where the operated cylinder state phase signal “estmodf” indicates “1”, the ECU 1 assumes that the internal combustion engine 20 is executing the all-cylinder operation and that a time sufficient to estimate a correct air-fuel ratio passes and calculates the fuel correction amount. Further, in a case where the operated cylinder state phase signal “estmodf” indicates “4”, the ECU 1 assumes that the internal combustion engine 20 is executing the cylinder-cut operation and that a time sufficient to estimate a correct air-fuel ratio passes and calculates the fuel correction amount.

Next, a flow of processing in the operated cylinder state determination routine will be described with reference to FIG. 13.

First, in step S601, the ECU 1 reads the operated cylinder state phase signal “estmodf”, the first cylinder air-fuel ratio estimated value “indafest1”, the second cylinder air-fuel ratio estimated value “indafest2”, the third cylinder air-fuel ratio estimated value “indafest3”, and the fourth cylinder air-fuel ratio estimated value “indafest4”. Further, the ECU 1 reads the first cylinder timing determination flag “xtmgcyl1”, the second cylinder timing determination flag “xtmgcyl2”, the third cylinder timing determination flag “xtmgcyl3”, and the fourth cylinder timing determination flag “xtmgcyl4”. After reading these, next, the ECU 1 proceeds to step S602.

Next, in step S602, the ECU 1 determines whether or not the operated cylinder state phase signal “estmodf” is “1”. A case where “1” is set to the operated cylinder state phase signal “estmodf” is a case where the internal combustion engine 20 is executing the all-cylinder operation and where a time sufficient to acquire a stable air-fuel ratio sensor value passes. In a case where it is determined that “1” is set to the operated cylinder state phase signal “estmodf” (S602: YES), next, the ECU 1 proceeds to step S603.

Next, in step S603, the ECU 1 calculates a standard air-fuel ratio estimated value “afestst”. The standard air-fuel ratio estimated value “afestst” is used as a target air-fuel ratio. In order to avoid a main feedback control from interfering with the present control, the ECU 1 does not use a target air-fuel ratio signal of the main feedback control. After calculating the standard air-fuel ratio estimated value “afestst”, next, the ECU 1 proceeds to step S604.

afestst=(indafest1+indafest2+indafest3+indafest4) (f5)

Next, in step S604, the ECU 1 determines whether or not “1” is set to the first cylinder timing determination flag “xtmgcyl1”. In a case where “1” is set to the first cylinder timing determination flag “xtmgcyl1”, it can be determined that this timing is a timing when the value of the first cylinder air-fuel ratio estimated value “indafest1” is updated. In a case where it is determined that “1” is set to the first cylinder timing determination flag “xtmgcyl1” (S604: YES), next, the ECU 1 proceeds to step S605.

Next, in step S605, the ECU 1 calculates a first cylinder air-fuel ratio deviation “deltaaf1” by using the following formula f6. The first cylinder air-fuel ratio deviation “deltaaf1” is a deviation between the first cylinder air-fuel ratio estimated value “indafest1” and the standard air-fuel ratio estimated value “afestst”. After calculating the first cylinder air-fuel ratio deviation “deltaaf1”, next, the ECU 1 proceeds to step S606.

deltaaf1=indafest1−afestst (f6)

Next, in step S606, the ECU 1 calculates a first cylinder fuel correction amount “indfcr1”. The first cylinder fuel correction amount “indfcr1” is calculated as a correction amount, which makes the first cylinder air-fuel ratio estimated value “indafest1” correspond to the standard air-fuel ratio estimated value “afestst”, on the basis of the first cylinder air-fuel deviation “deltaaf1”. The first cylinder fuel correction amount “indfcr1” is an amount which is multiplied to the fuel injection amount of the first cylinder #1. In this way, a variation in the air-fuel ratio for each of the cylinders 201 can be eliminated.

On the other hand, in a case where it is determined in step S604 that “1” is not set to the first cylinder timing determination flag “xtmgcyl1” (S604: NO), next, the ECU 1 proceeds to step S607.

Next, in step S607, the ECU 1 determines whether or not “1” is set to the second cylinder timing determination flag “xtmgcyl2”. In a case where “1” is set to the second cylinder timing determination flag “xtmgcyl2”, it can be determined that this timing is a timing when the value of a second cylinder air-fuel ratio estimated value “indafest2” is updated. In a case where “1” is set to the second cylinder timing determination flag “xtmgcyl2” (S607: YES), next, the ECU 1 proceeds to step S608. Thereafter, in steps S608 and S609, the ECU 1 performs the same processing as in steps S605 and S606 described above, thereby calculating a second cylinder fuel correction amount “indfcr2”.

On the other hand, in a case where it is determined in step S607 that “1” is not set to the second cylinder timing determination flag “xtmgcyl2” (S607: NO), next, the ECU 1 proceeds to step S610.

Next, in step S610, the ECU 1 determines whether or not “1” is set to the third cylinder timing determination flag “xtmgcyl3”. In a case where “1” is set to the third cylinder timing determination flag “xtmgcyl3”, it can be determined that this timing is a timing when the value of the third cylinder air-fuel ratio estimated value “indafest3” is updated. In a case where “1” is set to the third cylinder timing determination flag “xtmgcyl3” (S610: YES), next, the ECU 1 proceeds to step S611. Thereafter, in steps S611 and S612, the ECU 1 performs the same processing as in steps S605 and S606 described above, thereby calculating a third cylinder fuel correction amount “indfcr3”.

On the other hand, in a case where it is determined in step S610 that “1” is not set to the third cylinder timing determination flag “xtmgcyl3” (S610: NO), next, the ECU 1 proceeds to step S613.

Next, in step S613, the ECU 1 determines whether or not “1” is set to the fourth cylinder timing determination flag “xtmgcyl4”. In a case where “1” is set to the fourth cylinder timing determination flag “xtmgcyl4”, it can be determined that this timing is a timing when the value of the fourth cylinder air-fuel ratio estimated value “indafest4” is updated. In a case where “1” is set to the fourth cylinder timing determination flag “xtmgcyl4” (S613: YES), next, the ECU 1 proceeds to step S614. Thereafter, in steps S614 and S615, the ECU 1 performs the same processing as in steps S605 and S606 described above, thereby calculating a fourth cylinder fuel correction amount “indfcr4”.

In contrast to this, in a case where it is determined in step S613 that “1” is not set to the fourth cylinder timing determination flag “xtmgcyl4” (S613: NO), this timing is not a timing when the air-fuel ratio is estimated, so the ECU 1 does not calculate the fuel correction amount.

Further, in a case where it is determined in step S602 that the operated cylinder state phase signal “estmodf” is not “1” (S602: NO), it can be determined that the internal combustion engine 20 does not completely shift to the all-cylinder operation or is executing the cylinder-cut operation. In this case, next, the ECU 1 proceeds to step S616.

Next, in step S616, the ECU 1 sets “1” to the second cylinder fuel correction amount “indfcr2” and the third cylinder fuel correction amount “indfcr3”. This is because when the internal combustion engine 20 is executing the cylinder-cut operation, the ECU 1 does not make a fuel correction to the second cylinder #2 and the third cylinder #3 which are rested. Further, in a case where the operated cylinder state phase signal “estmodf” is “2” or “3”, which indicates that the internal combustion engine 20 is executing the all-cylinder operation or is shifting to the cylinder-cut operation, the air-fuel ratio is estimated but the probability of the estimated air-fuel ratio cannot be guaranteed, so the ECU 1 does not make the fuel correction. After setting “1” to the second cylinder fuel correction amount “indfcr2” and the third cylinder fuel correction amount “indfcr3”, next, the ECU 1 proceeds to step S617.

Next, in step S617, the ECU 1 determines whether or not the operated cylinder state phase signal “estmodf” is “4”. In other words, the ECU 1 determines whether or not: the internal combustion engine 20 is executing the cylinder-cut operation; and at the same time a time sufficient to acquire a correct air-fuel ratio sensor value passes. In a case where the operated cylinder state phase signal “estmodf” is “4” (S617: YES), next, the ECU 1 proceeds to step S618.

Next, in step S618, the ECU 1 calculates the standard air-fuel ratio estimated value “afestst” by using the following formula f7. A case of step S618 is different from a case of step S603, that is, the second cylinder #2 and the third cylinder #3 are rested and hence an air-fuel ratio is not estimated, so that the following formula f7 does not include the second cylinder air-fuel ratio estimated value “indafest2” and the third cylinder air-fuel ratio estimated value “indafest3”. After calculating the standard air-fuel ratio estimated value “afestst”, next, the ECU 1 proceeds to step S619.

afestst=(indafest1+indafest4)/2 (f7)

Next, in step S619, the ECU 1 determines whether or not “1” is set to the first cylinder timing determination flag “xtmgcyl1”. In a case where “1” is set to the first cylinder timing determination flag “xtmgcyl1”, it can be determined that this timing is a timing when the value of the first cylinder air-fuel ratio estimated value “indafest1” is updated. In a case where it is determined that “1” is set to the first cylinder timing determination flag “xtmgcyl1” (S619: YES), next, the ECU 1 proceeds to step S620.

Next, in step S620, the ECU 1 calculates the first cylinder air-fuel ratio deviation “deltaaf1”. Thereafter, in steps S620 and S621, the ECU 1 performs the same processing as in steps S605 and S606 which are described above, thereby calculating the first cylinder fuel correction amount “indfcr1”.

On the other hand, in a case where it is determined in step S619 that “1” is not set to the first cylinder timing determination flag “xtmgcyl1” (S619: NO), next, the ECU 1 proceeds to step S622.

Next, in step S622, the ECU 1 determines whether or not “1” is set to the fourth cylinder timing determination flag “xtmgcyl4”. In a case where “1” is set to the fourth cylinder timing determination flag “xtmgcyl4” (S622: YES), next, the ECU 1 proceeds to step S623.

Next, in step S623, the ECU 1 calculates the fourth cylinder air-fuel ratio deviation “deltaaf4”. Thereafter, in steps S623 and S624, the ECU 1 performs the same processing as in steps S614 and S615 which are described above, thereby calculating the fourth cylinder fuel correction amount “indfcr4”.

On the other hand, in a case where it is determined in step S622 that “1” is not set to the fourth cylinder timing determination flag “xtmgcyl4” (S622: NO), next, this timing is not a timing when the air-fuel ratio is estimated, so that the ECU 1 does not calculate the fuel correction amount.

In contrast to this, in a case where it is determined in step S617 that the operated cylinder state phase signal “estmodf” is not “4” (S617: NO), it can be determined that the fuel correction is not permitted. In this case, next, the ECU 1 proceeds to step S625.

Next, in step S625, the ECU 1 sets “1” to the first cylinder fuel correction amount “indfcr1” and to the fourth cylinder fuel correction amount “indfcr4”.

Here, it is assumed that, hypothetically, also in a case where the internal combustion engine 20 is executing the cylinder-cut operation, the ECU 1 estimates an air-fuel ratio by using the same observer as in a case where the internal combustion engine 20 is executing the all-cylinder operation and corrects the mount of the fuel. Then, a result in that case will be shown by dotted lines in FIG. 12.

In a case where the operated cylinder state phase signal “estmodf” is “3” or “4”, the internal combustion engine 20 is executing the cylinder-cut operation or is shifting to the cylinder-cut operation. In this case, when the ECU 1 estimates the air-fuel ratio in the individual cylinder air-fuel ratio estimation routine by using the same observer as in a case where the internal combustion engine 20 is executing the all-cylinder operation, as shown by the dotted lines in FIG. 12, all of the first cylinder air-fuel ratio estimated value “indafest1”, the second cylinder air-fuel ratio estimated value “indafest2”, the third cylinder air-fuel ratio estimated value “indafest3”, and the fourth cylinder air-fuel ratio estimated value “indafest4” deviate from the actual values of the air-fuel ratio.

When the ECU 1 calculates the first cylinder fuel correction amount “indfcr1”, the second cylinder fuel correction amount “indfcr2”, the third cylinder fuel correction amount “indfcr3”, and the fourth cylinder fuel correction amount “indfcr4” on the basis of the first cylinder air-fuel ratio estimated value “indafest1”,the second cylinder air-fuel ratio estimated value “indafest2”, the third cylinder air-fuel ratio estimated value “indafest3”, and the fourth cylinder air-fuel ratio estimated value “indafest4” which deviate from the actual values of the air-fuel ratio, also the first cylinder fuel correction amount “indfcr1”, the second cylinder fuel correction amount “indfcr2”, the third cylinder fuel correction amount “indfcr3”, and the fourth cylinder fuel correction amount “indfcr4” deviate from suitable values. For this reason, the cylinder 201 to which an unsuitable amount of fuel is supplied causes a malfunction of an exhaust gas component or drivability being impaired.

In contrast to this, in the present embodiment, in the individual cylinder air-fuel ratio estimation routine, when the internal combustion engine 20 is executing the cylinder-cut operation, the ECU 1 does not estimate the air-fuel ratio by using the observer when the internal combustion engine 20 is executing the all-cylinder operation. More specifically, when the internal combustion engine 20 is executing the cylinder-cut operation, the ECU 1 estimates the air-fuel ratio by using the observer different from the observer when the internal combustion engine 20 is executing the all-cylinder operation. Hence, it is possible to eliminate a variation in the air-fuel ratio between the cylinders 201 and hence to prevent the malfunction of an exhaust gas component or drivability being impaired.

The embodiment of the present disclosure has been described above with reference to the specific examples. However, the present disclosure is not limited to these specific examples. In other words, an example to which a person skilled in the art appropriately applies a design change to these specific examples is also included by the scope of the present disclosure as far as the example has a feature of the present disclosure. Each of the elements, which are included by the respective specific examples described above, and the arrangement, the condition, the shape, and the size of the element are not limited to those illustrated but can be modified as appropriate.

For example, in the embodiment described above, the individual cylinder air-fuel ratio control is performed when the internal combustion engine 20 is executing the all-cylinder operation and when the internal combustion engine 20 is executing the cylinder-cut operation. However, in place of this, the following action can be also performed: that is, when the internal combustion engine 20 is executing the all-cylinder operation, the individual cylinder air-fuel ratio control is performed, while when the internal combustion engine 20 is executing the cylinder-cut operation, the individual cylinder air-fuel ratio control is not performed. Also in this case, it is possible to inhibit the following situation: that is, when the internal combustion engine 20 is executing the cylinder-cut operation, the air-fuel ratio is estimated by using the observer when the internal combustion engine 20 is executing the all-cylinder operation, which causes the malfunction such as the exhaust gas component or drivability being impaired.

1. A control device that controls an operation of an internal combustion engine having a plurality of cylinders and that controls an air-fuel ratio of each of the cylinders on the basis of sensed information of an air-fuel ratio sensor provided in an exhaust collection part in which an exhaust gas exhausted from each of the cylinders is collected, the control device comprising:
an all-cylinder operation execution part that executes an all-cylinder operation to operate all of the plurality of cylinders;
a cylinder-cut operation execution part that executes a cylinder-cut operation to rest a part of the cylinders of the plurality of cylinders and to operate the other of the cylinders
an operation shift part that shifts one of the all-cylinder operation and the cylinder-cut operation to the other of them;
an operation state determination part that determines which of an operation state where the internal combustion engine is executing the all-cylinder operation, an operation state where the internal combustion engine is executing the cylinder-cut operation, and an operation state where the internal combustion engine is shifting to one of the all-cylinder operation and the cylinder-cut operation, the internal combustion engine is in on the basis of the operation shift part and the sensed information of the air-fuel ratio sensor;
an air-fuel ratio estimation part that estimates an air-fuel ratio of each of the cylinders on the basis of the sensed information of the air-fuel ratio sensor; and
a fuel correction part that corrects an amount of fuel to be supplied to each of the cylinders on the basis of the air-fuel ratio of each of the cylinders which is estimated by the air-fuel ratio estimation part, wherein
in a case where the internal combustion engine is executing the all-cylinder operation, the air-fuel ratio estimation part estimates the air-fuel ratio of each of the cylinders by using a first observer, whereas in a case where the internal combustion engine is executing the cylinder-cut operation, the air-fuel ratio estimation part does not estimate the air-fuel ratio of each of the cylinders by using the first observer.

2. A control device according to claim 1, wherein
in a case where an operation state of the internal combustion engine is shifting, the fuel correction part does not correct the amount of fuel to be supplied to each of the cylinders.

3. A control device according to claim 1, wherein
in a case where the internal combustion engine is executing the cylinder-cut operation, the air-fuel ratio estimation part estimates the air-fuel ratio of the cylinder, which is being operated, by using a second observer which is different from the first observer.

4. A control device according to claim 1, wherein
the air-fuel ratio estimation part does not estimate the air-fuel ratio of each of the cylinders on the basis of the sensed information of the air-fuel ratio sensor in a first predetermined time which passes after the part of the cylinders starts to be rested and in a second predetermined time which passes after the part of the cylinders starts to be operated.

5. A control device according to claim 1, further comprising:
a sensed information acquisition part that acquires the sensed information of the air-fuel ratio sensor at a predetermined timing, wherein
the sensed information acquisition part acquires the sensed information of the air-fuel ratio sensor on the basis of a standard signal corresponding to a crank angle of each of the cylinders, and
the standard signal is set in such a way as to be different from each other between when the internal combustion engine is executing the all-cylinder operation and when the internal combustion engine is executing the cylinder-cut operation.
